(19) United States
(12) Patent Application Publication
(10) Pub. No.: US 2013/0246169 A1
(43) Pub. Date: Sep. 19, 2013

(54) SYSTEMS AND METHODS FOR DYNAMIC IMAGE AMPLIFICATION

(71) Applicants: Eric Z. Berry, New York, NY (US); Shaun T. Zacharia, New York, NY (US); Ari Lewine, New York, NY (US)

(72) Inventors: Eric Z. Berry, New York, NY (US); Shaun T. Zacharia, New York, NY (US); Ari Lewine, New York, NY (US)

(21) Appl. No.: 13/843,582

(22) Filed: Mar. 15, 2013

Related U.S. Application Data
(60) Provisional application No. 61/612,397, filed on Mar. 19, 2012.

(51) Int. Cl. G06Q 30/02

(52) U.S. Cl. CPC G06Q 30/0251
USPC 705/14.49

(57) ABSTRACT

According to various embodiments, a system and a method for selecting images for advertisements using a computer system are disclosed. In one example, the method comprises computing, by the computer system, a plurality of valuations of a plurality of images, the plurality of valuations indicating levels of at least one of social engagement and personal engagement with the plurality of images, and identifying at least one image from the plurality of images based on a valuation of the at least one image from the plurality of valuations.

### RELATED APPLICATIONS

This application claims priority under U.S.C. §119(e) to U.S. Provisional Application Ser. No. 61/612,397, entitled “SYSTEMS AND METHODS FOR PROVIDING,” filed on Mar. 19, 2012, which is hereby incorporated by reference in its entirety.

### BACKGROUND

1. Technical Field

Embodiments disclosed herein relate generally to systems of advertising using digital images and, more particularly, to systems and processes of selecting, deploying, and promoting targeted images for advertisements based on dynamic image amplification.

2. Discussion

Brands and advertising agencies produce high quality, engaging digital content for their consumers. Consumers engage with this digital content through a variety of devices and platforms as the content is delivered to them over the internet. Traditionally, the delivery of advertising content took a single, one-hop path from the agencies that produced the advertising content to individual end consumers of that content. With the increasingly imaged-based nature of the internet and the rise of social networking, the path over which advertising content may travel has expanded as consumers engage with digital image content and then share that content with members of their own social networks. When content is shared between consumers, brands gain valuable exposure to larger numbers of consumers.

### SUMMARY

According to some aspects of the invention, it is appreciated that an active placement of image-centric advertising, which uses knowledge that a particular image has a high probability of resonating with its audience, can be more effective than a passive approach involving no use of metrics for likely effectiveness of a particular advertisement. Having timely ability to measure image content that engages particular consumer segments allows a brand or an advertising agent to craft future advertising that is more likely to resonate with those same consumer segments. As one of the most effective forms of advertising comes through the endorsement of a product or service by its actual customers, having the ability to measure how, where, and when a particular brand's content is shared among consumers themselves produces even stronger feedback that factors into the creation of relevant, targeted advertising.

In broad overview, aspects and embodiments disclosed herein provide for a system that allows for a brand to digitally fingerprint its image-based content, track the spread of that content across various local, public and social networks, measure the engagement of consumers with fingerprinted content across these various locations, craft new image-based advertising content based on the analysis of engagement measurements, and deliver new advertising content that promotes the most engaged and shared content with appropriate audiences.

According to one aspect, a method of providing advertising using a computer system is disclosed. In one embodiment, the method comprises receiving, by the computer system, a request for advertising content, the request including information descriptive of a context for the adverting content, selecting at least one image from a plurality of images to include in the advertising content based on the context, altering the at least one image according to the context to generate at least one altered image, and transmitting the at least one altered image to a requestor of the advertising content.

In one example, transmitting the at least one altered image includes transmitting a display advertising unit that includes a template, the template specifying display characteristics of the at least one image within the display advertising unit. In at least one example, the method includes receiving, by another computer system different from the computer system, information that references the advertising content, processing the information, and transmitting, to the computer system, the request for advertising content in response to processing the information. In some examples, receiving the information includes receiving a reference to a native object, the native object including a reference to the at least one image.

In other examples, the method further includes selecting the at least one image includes computing a valuation metric that indicates the at least one image is more highly engaging, within the context, than others of the plurality of images. In at least one example, altering the at least one image includes at least one of resizing the at least one image and cropping the at least one image. In this example, collecting the plurality of images from at least one computer system different from the computer system, and identifying a plurality of features depicted in the plurality of images. In one example, altering the at least one image includes maintaining at least one feature of the plurality of features, the at least one feature being included in the at least one image.

In some examples, collecting the plurality of images includes collecting the plurality of images from at least one website. In addition, identifying the plurality of features may include identifying at least one of a human face, an object, and a logo. In one example, the method may further comprise receiving information descriptive of engagements with the at least one image. In an example, receiving the information descriptive of the engagements includes receiving information from at least one of a social network website, an engagement broker website, and a web server hosting a tagged pixel. In addition, receiving the information descriptive of the engagements may further include receiving information descriptive of a process executed by another computer system different from the computer system. Further, receiving the information descriptive of the engagements may include receiving information descriptive of at least one of a like, a re-pin, a tweet, a heart, a click, a save, and an attach.

According to another aspect, a computer system comprising a first computer providing advertising system comprising a memory, and at least one processor coupled to the memory is disclosed. In one embodiment, the at least one processor is configured to receive a request for advertising content, the request including information descriptive of a context for the adverting content, select at least one image from a plurality of images to include in the advertising content based on the context, alter the at least one image according to the context to generate at least one altered image, and transmit the at least one altered image to a requestor of the advertising content.

In one example, the at least one processor is configured to transmit the at least one altered image by transmitting a display advertising unit that includes a template, the template specifying display characteristics of the at least one image within the display advertising unit. In another example, the computer system further comprises a second computer system configured to receive information that references the advertising content, process the information, and transmit, to the first computer system, the request for advertising content in response to processing the information. In at least one example, the second computer system is further configured to receive the information by receiving information including a reference to a native object, the native object including a reference to the at least one image.

In an additional example, the at least one processor is configured to select the at least one image by computing a valuation metric that indicates the at least one image is more highly engaging, within the context, than others of the plurality of images. In this example, the at least one processor is configured to alter the at least one image by at least one of resizing the at least one image and cropping the at least one image. In the system, the at least one processor may be further configured to collect the plurality of images from a third computer system different from the first and the second computer system, identify a plurality of features depicted in the plurality of images, and alter the at least one image by maintaining at least one feature of the plurality of features, the at least one feature being included in the at least one image.

In at least one example, the at least one processor is configured to collect the plurality of images by collecting the plurality of images from at least one website. In this example, the at least one processor is configured to identify the plurality of features by identifying at least one of a human face, an object, and a logo. In one example, the at least one processor is configured to receive information descriptive of engagements with the at least one image. In addition, the at least one processor may be configured to receive the information descriptive of the engagements by receiving information from at least one of a social network website, an engagement broker website, and a web server hosting a tagged pixel. Further, the at least one processor may be configured to receive the information descriptive of the engagements by receiving information descriptive of a process executed by a fourth computer system different from the first, the second and the third computer system. In at least one example, the at least one processor is configured to receive the information descriptive of the engagements by receiving information descriptive of at least one of a like, a re-pin, a tweet, a heart, a click, a save, and an attach.

According to another aspect, a non-transitory computer readable medium storing instructions for providing advertising is disclosed. In one embodiment, the instructions being executable by at least one processor of a computer system, the instructions instructing the computer system to receive a request for advertising content, the request including information descriptive of a context for the adverting content, select at least one image from a plurality of images to include in the advertising content based on the context, alter the at least one image according to the context to generate at least one altered image, and transmit the at least one altered image to a requestor of the advertising content.

In one example, the instructions to transmit the at least one altered image include instructions to transmit a display advertising unit that includes a template, the template specifying display characteristics of the at least one image within the display advertising unit.

According to one aspect, a method of providing advertising using a computer system is disclosed. In one embodiment, the method comprises receiving, by the computer system, a request for advertising content, the request including information descriptive of a context for the adverting content, selecting at least one image from a plurality of images to include in the advertising content based on the context, altering the at least one image according to the context to generate at least one altered image, and transmitting the at least one altered image to a requestor of the advertising content.

In one example, transmitting the at least one altered image includes transmitting a display advertising unit that includes a template, the template specifying display characteristics of the at least one image within the display advertising unit. In at least one example, the method includes receiving, by another computer system different from the computer system, information that references the advertising content, processing the information, and transmitting, to the computer system, the request for advertising content in response to processing the information. In some examples, receiving the information includes receiving a reference to a native object, the native object including a reference to the at least one image.

In other examples, the method further includes selecting the at least one image includes computing a valuation metric that indicates the at least one image is more highly engaging, within the context, than others of the plurality of images. In at least one example, altering the at least one image includes at least one of resizing the at least one image and cropping the at least one image. In this example, collecting the plurality of images from at least one computer system different from the computer system, and identifying a plurality of features depicted in the plurality of images. In one example, altering the at least one image includes maintaining at least one feature of the plurality of features, the at least one feature being included in the at least one image.

In some examples, collecting the plurality of images includes collecting the plurality of images from at least one website. In addition, identifying the plurality of features may include identifying at least one of a human face, an object, and a logo. In one example, the method may further comprise receiving information descriptive of engagements with the at least one image. In an example, receiving the information descriptive of the engagements includes receiving information from at least one of a social network website, an engagement broker website, and a web server hosting a tagged pixel. In addition, receiving the information descriptive of the engagements may further include receiving information descriptive of a process executed by another computer system different from the computer system. Further, receiving the information descriptive of the engagements may include receiving information descriptive of at least one of a like, a re-pin, a tweet, a heart, a click, a save, and an attach.

According to another aspect, a computer system comprising a first computer providing advertising system comprising a memory, and at least one processor coupled to the memory is disclosed. In one embodiment, the at least one processor is configured to receive a request for advertising content, the request including information descriptive of a context for the adverting content, select at least one image from a plurality of images to include in the advertising content based on the context, alter the at least one image according to the context to generate at least one altered image, and transmit the at least one altered image to a requestor of the advertising content.

In one example, the at least one processor is configured to transmit the at least one altered image by transmitting a display advertising unit that includes a template, the template specifying display characteristics of the at least one image within the display advertising unit. In another example, the computer system further comprises a second computer system configured to receive information that references the advertising content, process the information, and transmit, to the first computer system, the request for advertising content in response to processing the information. In at least one example, the second computer system is further configured to receive the information by receiving information including a reference to a native object, the native object including a reference to the at least one image.

In an additional example, the at least one processor is configured to select the at least one image by computing a valuation metric that indicates the at least one image is more highly engaging, within the context, than others of the plurality of images. In this example, the at least one processor is configured to alter the at least one image by at least one of resizing the at least one image and cropping the at least one image. In the system, the at least one processor may be further configured to collect the plurality of images from a third computer system different from the first and the second computer system, identify a plurality of features depicted in the plurality of images, and alter the at least one image by maintaining at least one feature of the plurality of features, the at least one feature being included in the at least one image.

In at least one example, the at least one processor is configured to collect the plurality of images by collecting the plurality of images from at least one website. In this example, the at least one processor is configured to identify the plurality of features by identifying at least one of a human face, an object, and a logo. In one example, the at least one processor is configured to receive information descriptive of engagements with the at least one image. In addition, the at least one processor may be configured to receive the information descriptive of the engagements by receiving information from at least one of a social network website, an engagement broker website, and a web server hosting a tagged pixel. Further, the at least one processor may be configured to receive the information descriptive of the engagements by receiving information descriptive of a process executed by a fourth computer system different from the first, the second and the third computer system. In at least one example, the at least one processor is configured to receive the information descriptive of the engagements by receiving information descriptive of at least one of a like, a re-pin, a tweet, a heart, a click, a save, and an attach.

According to another aspect, a non-transitory computer readable medium storing instructions for providing advertising is disclosed. In one embodiment, the instructions being executable by at least one processor of a computer system, the instructions instructing the computer system to receive a request for advertising content, the request including information descriptive of a context for the adverting content, select at least one image from a plurality of images to include in the advertising content based on the context, alter the at least one image according to the context to generate at least one altered image, and transmit the at least one altered image to a requestor of the advertising content.

In one example, the instructions to transmit the at least one altered image include instructions to transmit a display advertising unit that includes a template, the template specifying display characteristics of the at least one image within the display advertising unit.

According to one aspect a method for selecting images for advertisements using a computer system is disclosed. In one embodiment, the method comprises computing, by the computer system, a plurality of valuations of a plurality of images, the plurality of valuations indicating levels of at least one of social engagement and personal engagement with the plurality of images, and identifying at least one image from the plurality of images based on a valuation of the at least one image from the plurality of valuations.

In one example, computing the plurality of valuations includes computing one or more valuations based on engagement data. In this example, computing the one or more valuations based on the engagement data includes computing at least one valuation based on a time of engagement included in the engagement data. In some examples, computing the one or more valuations based on the engagement data includes computing at least one valuation based on a frequency of engagement included in the engagement data. In at least one example, computing the one or more valuations based on the engagement data includes computing at least one valuation based on a sharing metric included in the engagement data.

In some examples, computing the plurality of valuations includes terminating computation within a predetermined time limit. In at least one example, computing the plurality of valuations includes performing multiple valuations in parallel. In this example, performing the multiple valuations includes identifying the valuation of the at least one image as being higher than another valuation of the plurality of valuations.

According to another aspect, a computer system for selecting images for advertisements is disclosed. In one embodiment, the computer system comprises a memory, and at least one processor coupled to the memory, the at least one processor configured to compute a plurality of valuations of a plurality of images, the plurality of valuations indicating levels of at least one of social engagement and personal engagement with the plurality of images, and identify at least one image from the plurality of images based on a valuation of the at least one image from the plurality of valuations.

In one example, the at least one processor is configured to compute the plurality of valuations by computing one or more valuations based on engagement data. In this example, the at least one processor is configured to compute the one or more valuations based on the engagement data by computing at least one valuation based on a time of engagement included in the engagement data. In another example, the at least one processor is configured to compute the one or more valuations based on the engagement data by computing at least one valuation based on a frequency of engagement included in the engagement data. In some examples, the at least one processor is configured to compute the one or more valuations based on the engagement data by computing at least one valuation based on a sharing metric included in the engagement data.

In one example, the at least one processor is configured to compute the plurality of valuations by terminating computation within a predetermined time limit. In this example, the at least one processor is configured to compute the plurality of valuations by performing multiple valuations in parallel. In another example, the at least one processor is configured to perform the multiple valuations by identifying the valuation of the at least one image as being higher than another valuation of the plurality of valuations.

According to another aspect a non-transitory computer readable medium storing instructions for selecting images for advertisements, the instructions being executable by at least one processor of a computer system is disclosed. In one embodiment, the instructions instruct the computer system to compute a plurality of valuations of a plurality of images, the plurality of valuations indicating levels of at least one of social engagement and personal engagement with the plurality of images, and identify at least one image from the plurality of images based on a valuation of the at least one image from the plurality of valuations.

In one example, the instructions that instruct the computer system to compute the plurality of valuations include instructions that instruct the computer system to compute one or more valuations based on engagement data. In this example, the instructions that instruct the computer system to compute the one or more valuations based on the engagement data include instructions that instruct the computer system to compute at least one valuation based on a time of engagement included in the engagement data.

In another example, the instructions that instruct the computer system to compute the one or more valuations based on the engagement data include instructions that instruct the computer system to compute at least one valuation based on a frequency of engagement included in the engagement data. In yet another example, the instructions that instruct the computer system to compute the one or more valuations based on the engagement data include instructions that instruct the computer system to compute at least one valuation based on a sharing metric included in the engagement data.

In some examples, the instructions that instruct the computer system to compute the plurality of valuations include instructions that instruct the computer system to terminate computation within a predetermined time limit. In this example, the instructions that instruct the computer system to compute the plurality of valuations include instructions that instruct the computer system to perform multiple valuations in parallel. In another example, the instructions that instruct the computer system to perform the multiple valuations include instructions that instruct the computer system to identify the valuation of the at least one image as being higher than another valuation of the plurality of valuations.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings are not intended to be drawn to scale. In the drawings, each identical or nearly identical component that is illustrated in various figures is represented by a like numeral. For purposes of clarity, not every component may be labeled in every drawing. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a context diagram of an image engagement analysis content production and advertising system;

FIG. 2 is a diagram of a sample web crawler that systematically browses the internet to find images containing appropriate image fingerprints;

FIG. 3 is a diagram of sample integrations with social networks in which product and image engagement is analyzed;

FIG. 4 is a diagram of an array of high performance web servers that collects on-site user engagement points;

FIG. 5 is a diagram of a sample integration with data providers in which engagement data is correlated with contextual and audience data;

FIG. 6 is a diagram representing the data flow associated with a website's interaction with a third-party data broker;

FIG. 7 is a diagram of the creation of advertising units using the most engaged content for a brand;

FIG. 8 is a simplified code sample for a JSON object used for tracking various content metadata and user engagement data for an example image;

FIG. 9 is a diagram representing the purchase and placement of such advertising units on appropriate web pages for appropriate audiences;

FIG. 10 is a diagram representing the use of sharing and engagement data to produce strategic guidance for future decision making purposes;

FIG. 11 is diagram of an example distributed content refactoring server integrated with a content delivery network;

FIG. 12 is a diagram of a real-time bidding network for sponsored content;

FIG. 13 is a sample feedback mechanism for collecting engagement metrics through various native integrations;

FIG. 14 is a sample mechanism for collecting engagement of sponsored images on websites through click tracking;

FIGS. 15A and 15B are exemplary flow diagrams describing the process of image tracking, consumer image engagement measurement and analysis, as well as advertisement purchasing, creation, placement, and tracking;

FIG. 16A is a diagram of a content overlay placed on the original elements of a web page or mobile application;

FIG. 16B is a diagram of a native object overlay placed on a web page or mobile application;

FIG. 16C is a diagram of an updated content overlay placed on the same web site depicted in FIG. 16A showing dynamic content overlay; and

FIG. 17 is a diagram of a computer system used for executing at least part of the consumer content analysis, production, and advertising system.

### DETAILED DESCRIPTION

At least some aspects and examples disclosed herein relate to apparatus and processes for digital content production and advertising utilizing image engagement analysis that allows for the automated creation and delivery of targeted image-based advertising. An image engagement may include any activity that results in a computer system operating on image data associated with a particular brand or other identifier of source, sponsorship or affiliation. Examples of image engagement include viewing a web page on which a particular image is hosted, clicking on an image hosted in a particular web page, sharing an image within the context of a social network, via e-mail, instant messaging or other means of digital communication, hovering over an image for a specified period, or saving a hosted image to a local machine. Examples of content production include analyzing the salient content of a stock of images associated with a brand, refactoring existing image content preserving salient features based on the target location for deployment, adding features to existing image content that encourage further consumer engagement. Examples of image engagement analysis include collection of information related to presentation context and viewer demographics, as well as scoring the effectiveness of an engagement. As described further below, in at least one embodiment, the apparatus and processes track the propagation of, and consumer interaction with, image-based advertising content across a variety of local, public, and social networks, and provide mechanisms for producing new image based advertising content based on the level of engagement consumers have with those images.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Image Engagement Analysis Based Digital Content Production and Advertisement System

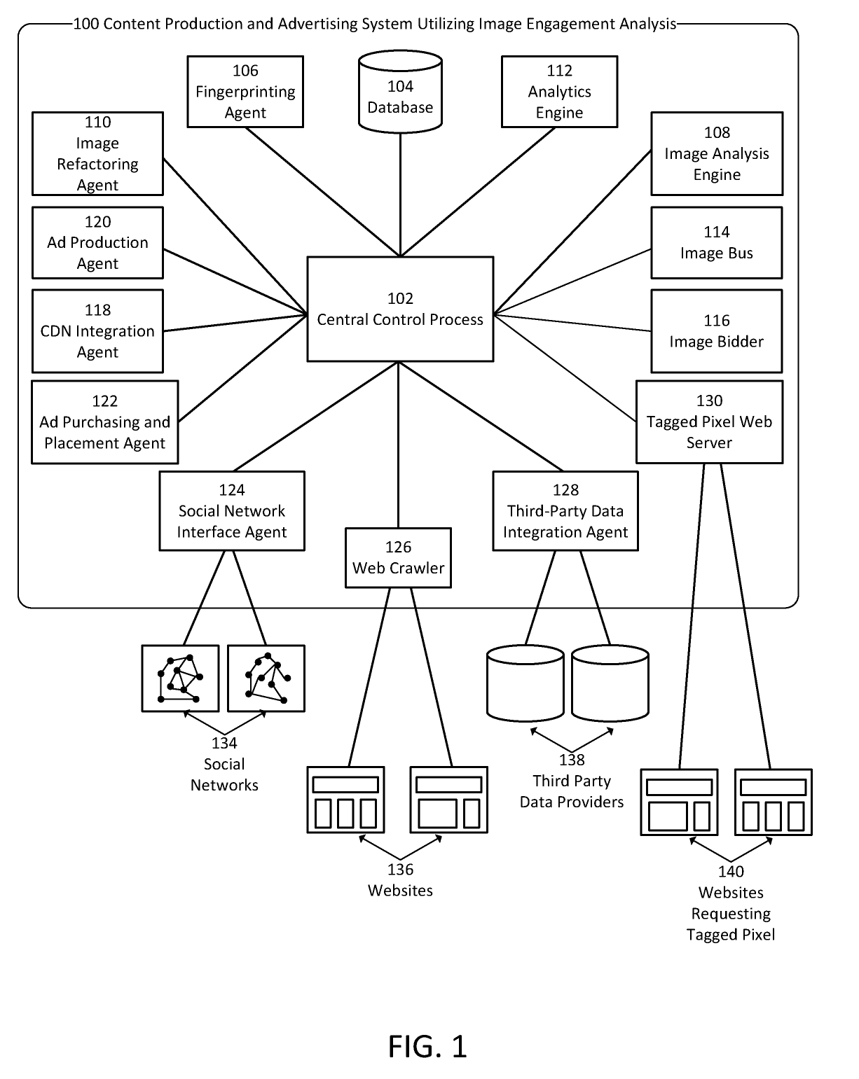

Various embodiments implement a digital content production and advertisement system that is configured to track and analyze consumer engagement with image-based advertising and produce new targeted advertising using one or more computer systems. FIG. 1 illustrates one of these embodiments, a digital content production and advertising system 100, containing multiple internal components and within the context of several external entities. As shown in FIG. 1, the internal components of the image analysis based digital content production and advertising system include a central control process 102, a digital image and fingerprint database 104, a digital fingerprinting agent 106, an image analysis engine 108, an image refactoring agent 110, an image engagement analysis engine 112, an image bus 114, an image bidder 116, a content delivery network (CDN) integration agent 118, an advertisement production agent, an advertisement placement and purchasing agent 122, a social network interface agent 124, a web crawling agent 126, a third-party data provider interface agent 128, and a tagged pixel web server hosting agent 130. As shown in FIG. 1, the external entities with which the above system may interact include various social networks 130, externally hosted websites 132, various third-party consumer tracking data providers 134 having knowledge about consumer engagement with fingerprinted images, and various websites requesting tagged pixels 140. An externally hosted website 132 or social network 130 may include tracked fingerprinted image content. Examples of external websites include YAHOO!, MSN, GOOGLE, GMAIL, HOTMAIL, AOL Mail, and more. Examples of such social networks include the FACEBOOK social networking service available online from Facebook, Inc. of Menlo Park, Calif., the TWITTER social networking and micro-blogging service available online from Twitter, Inc. of San Francisco, Calif., the FOURSQUARE location based social network system available online from Foursquare Labs, Inc. of New York, N.Y., the GOOGLE+ social networking system available online from Google Inc. of Mountain View, Calif., the LINKEDIN social networking system available online from LinkedIn Corporation of Mountain View, Calif., the PINTEREST social networking system available online from Pinterest of San Francisco, Calif., the TUMBLR social networking system available from Tumblr, Inc. of New York, N.Y., the INSTAGRAM social networking system available from Facebook, Inc. of Menlo Park, Calif., and others.

As shown in FIG. 1, in one embodiment, a central processing engine 102 instructs a digital fingerprinting agent 106 and an image analysis engine 108 to process a stock of images associated with a particular brand that have been loaded into storage. Upon processing the stock of images, fingerprints and salient characteristics for those images, as described in more detail below, are stored in a digital fingerprint database 104. A web crawling agent 126 systematically browses external websites 132 looking for instances of images whose calculated digital fingerprints match existing digital fingerprints stored in the fingerprint database 106. A social network interface agent 124 interacts with various social networks 134 to obtain consumer engagement information related to fingerprinted images hosted within those social networks.

Consumer engagement information for images that have been engaged on various public websites is also obtained by a third party data integration agent 128 from various third party data providers 138 that are configured to collect user interaction data for sites with which they do business. As will be explained in more detail below, a tagged pixel web server also obtains direct feedback on user image engagement from public websites that request specific tagged pixels as a result of specific end user actions related to an image hosted on various public websites. An engagement analysis engine 108 collects image location information as well as consumer image engagement information from a social network interface agent 124, a web crawling agent 126, a third-party data provider interface agent 128, and a tagged pixel web server 130, and then operates on the aggregated consumer image engagement data. Based on analysis performed on this consumer image engagement data by an image engagement analysis engine 108, an image refactoring agent 110 receives instructions on which images to operate. The image refactoring agent 110 then produces alternative versions of fingerprinted images that have been deemed most highly engaging and fit within the requirements of new targeted advertisement locations. An advertisement purchasing and placement agent 120 can then utilize recommendations provided by an engagement analysis engine 108 to either automate the process of placing updated image content in new advertisement locations or provide recommendations on possible locations for placing updated image content.

According to various embodiments, a brand or agency seeking to create targeted advertisements containing branded image content may utilize an image engagement analysis content production system 100 to produce content based on consumer engagement with any external or internal content source illustrated in FIG. 1. A set of a branded image content loaded into data store 104 is processed by digital fingerprinting agent 106 using one of a variety of fingerprinting methodologies. According to various embodiments, example fingerprinting methodologies may include analysis by wavelet decomposition, analysis of brightness of image regions, creation of color histograms, analysis by of interest points using algorithms such as those described by Schmid and Moor, as well as other techniques. A choice of fingerprinting methodology utilized depends upon both the size of an image dataset as well as whether an image is to be identically matched or just nearly matched. Examples of a nearly matched image might include a thumbnail image that was produced from an original image by scaling down the total pixel size, an image whose pixel density is resampled, or a cropped image in comparison to an original image. Near match fingerprinting methodologies utilized are resistant to scaling, formatting, and minor cropping of the images, whereas exact fingerprinting methodologies are not. Examples of resistant fingerprinting methodologies are described below. A fingerprint having the qualities sufficient to reliably identify near matches without including false positives beyond a very low tolerance is robust for use on images that may have been resampled and also may have been resized.

In further embodiments, additional analytics are performed on the fingerprinted images stored in data store 104 by the image analysis engine 108 to determine an image's salient features. In some embodiments analytics performed on fingerprinted images include face and body detection methods including, but not limited to, Haar cascades. In further embodiments, analyzing salient features within a fingerprinted image may also include acts of color analysis and grouping color using buckets in a visual-similarity color space, such as CIE LAB. In other embodiments, analysis is performed on fingerprinted images using the extraction of primary colors by means of background exclusion analysis and similar color groupings. As an example of color analysis, the salient colors of an image may be found by first analyzing an image to exclude its background, consisting of operations such as analyzing the corners of an image for color similarity and detecting common background patterns. After background exclusion, an image's remaining features are converted to a color space in which Euclidean distance represents perceived color similarity with buckets grouping similar colors. Pixels within an image are added to color buckets and those color buckets over a certain threshold value are identified, merged as appropriate, and returned as the salient colors of an image. Background colors may be excluded through an analysis of colors near image corners, analysis of colors relative to edges identified within an image, and analyzing numerous images from the same source to discern likely background patterns.

In some embodiments, analyzing salient image features may also include an act of edge detection. Edge detection within an image is performed to find discontinuities within an image that act as proxies for regions of interest within an image. For example, a body present within an image will have edges surrounding that body. Detection of those edges provides basis for further analysis of an image, such as a likely focal center and likely preferred image orientation of an image. The act of edge detection may include filtering methods such as those described by Sobel and Canny-Deriche. In some embodiments, analyzing salient image features may also include gravity analysis to find the focal center of the image. The act of gravity analysis may utilize a variety of edge detection and smoothing techniques. In some embodiments, analyzing salient image features may also include finding the maximum boundaries of identified edges found using edge detection algorithms. All analysis performed in determining an image's salient features may be used in subsequent steps when an image needs to be cropped in such a manner that preserves that image's most important features and orientation.

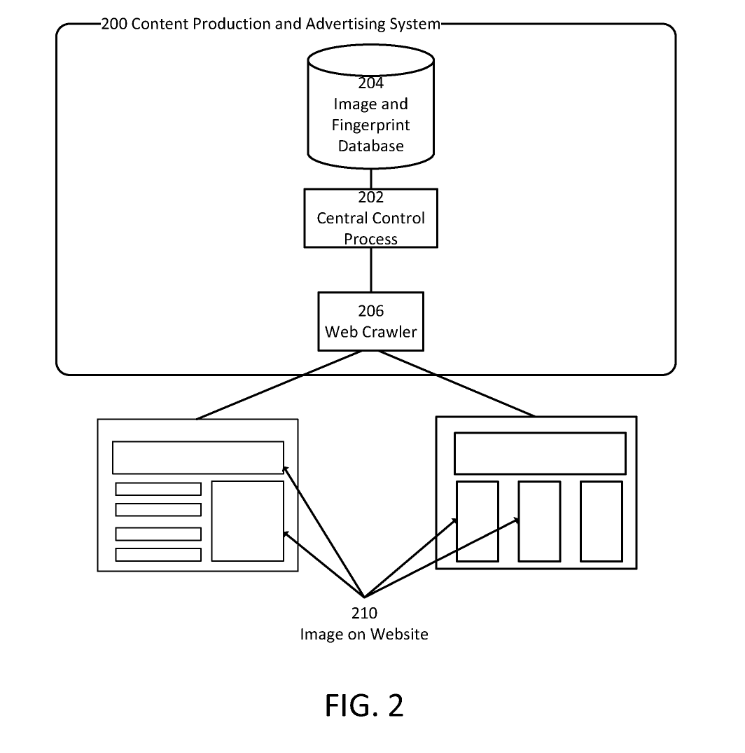

In various embodiments a web crawler 206 systematically browses the internet to find images 210 on websites 208, as shown in FIG. 2. In one embodiment, a web crawler implementation includes a number of identical processes executing on a cluster of computer systems that are each fed a list of pre-defined URLs, each process fetches an assigned subset of web pages associated with an assigned subset of URLs. Each computer system parses its retrieved HTML using parsing logic that is capable of handling both well-formed and poorly formatted HTML. A well-formed HTML document is one where all elements that are opened are subsequently closed, and all elements are properly nested such that there is no overlap. In a well-formed HTML document, a single root element contains all other elements in the document. Parsing logic extracts information related to images present on a retrieved page, image related meta-data, meta-data related to the overall web page, as well as embedded links to other web pages. In some embodiments, links to retrieved URLs are fed into a store of URLs for further processing by a cluster of web crawler processes. In some embodiments, identified images are sent to a central processing system 202, where instructions are provided for comparing identified images to existing fingerprinted images stored in database 204. In further embodiments, instructions are provided by a central processing system to a digital fingerprinting agent such as fingerprinting agent 106 from FIG. 1 to fingerprint the newly obtained images and store those images and fingerprints within a digital fingerprint and image database 204.

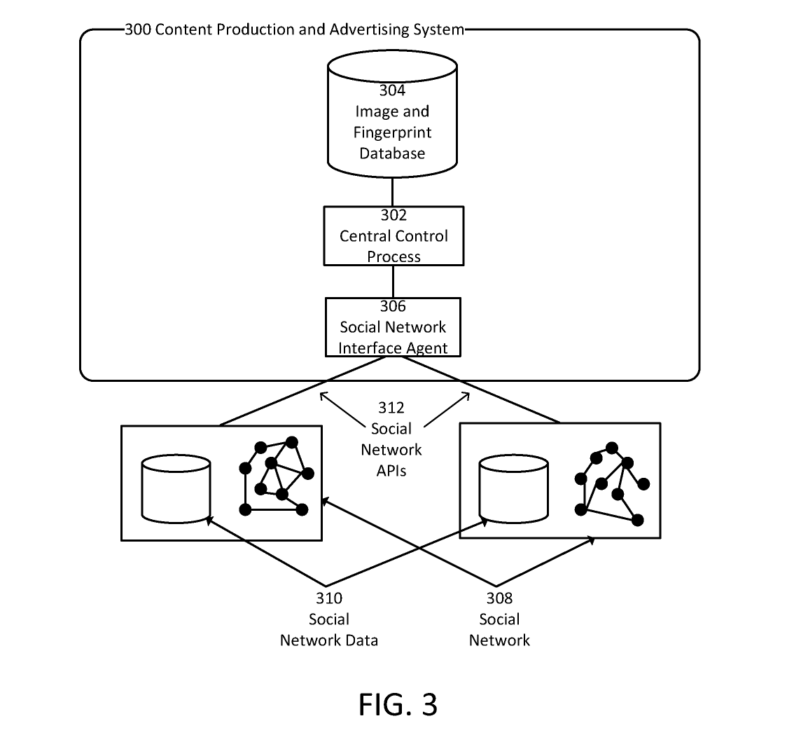

As shown in FIG. 3, in some embodiments, a social network interface agent 306 integrates using a specialized application programming interface (API) 312 to one of a variety of social networks 308. Social networks contain data 310 about the consumer sharing and engagement of images. Information is retrieved from a social network related to the sharing and engagement of a brand's visual assets is retrieved via an appropriate API associated with a particular network. Examples of information retrieved include obtaining information about customer engagement with a brand's image on PINTEREST. PINTEREST allows users to “pin” images to a virtual pin board to share with members of a social network. Information obtainable from an appropriate social network API include information such as demographic data about the consumer that “pinned” the image, the URL of the site originally hosting an image from which a consumer “pinned” the image, a consumer's other pinned images.

On other social networks, various APIs can be used to obtain a consumer's “likes”, as well as information about “followers” and those individuals the user is “following”. Similar information can be obtained by integration with other social networks, such as FACEBOOK, TWITTER, TUMBLR, INSTAGRAM, and others by utilizing separate APIs that are specialized to those social networks. While FIG. 3 represents only two social network integrations, there is no actual limit to the number of social networks with which the system can integrate. In some embodiments, information obtained by the social network interface agent 306 is passed to a central processing unit 302 which normalizes images obtained from the social network and saves all data obtained from the social network relative to the image in an image database 304.

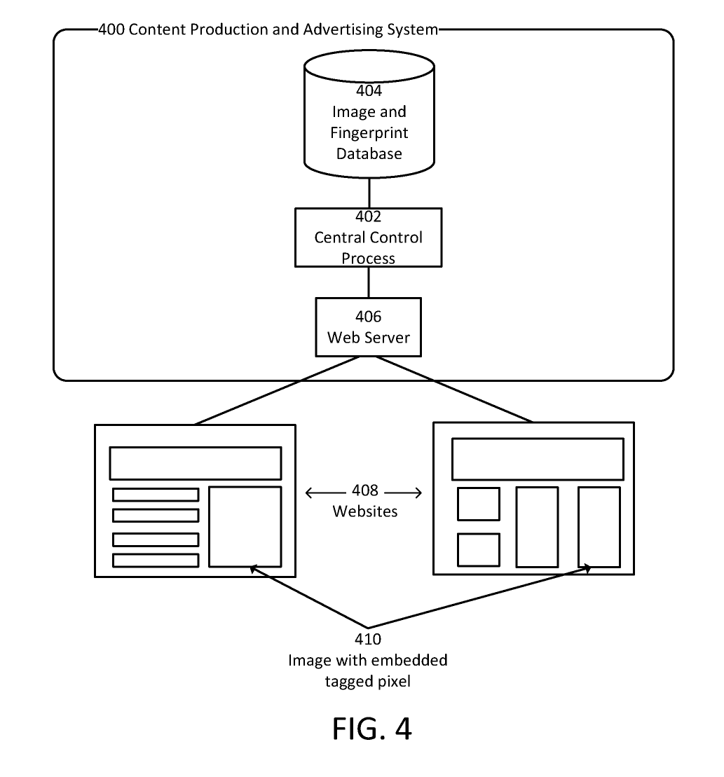

As shown in FIG. 4, in some embodiments, a webserver hosting tagged pixels 406 communicates with websites 408 containing requests tagged pixels 410 associated with fingerprinted images related to a particular brand. In some embodiments, a web server processes collected data related to requests for tagged pixels that correspond to consumer engagement with tagged images. Tags may be implemented in any language that allows for browser scripting such as JavaScript, Flash from Adobe Systems, ActionScript, and others. In some embodiments, a consumer triggers a browser to communicate with a webserver hosting agent by performing operations including sharing an image, saving an image, clicking on an image, or some other action that can be characterized as a high-confidence signal of engagement. Upon a consumer performing an appropriate interaction with an image a web browser, the embedded tag triggers the consumer's web browser to notify a web server that such activity has occurred. In some embodiments, the act of notifying a web browser that consumer engagement has occurred may be performed by requesting a specially formatted pixel for display in a consumer's web browser. As one possible example of such a pixel request, the following HTTP request may be sent from a user's web browser to a web server: http://ENDPOINT.COM/HANDLER?uid=COOKIE_ID&id=CLIENT_ID&ref=SITE_OF_ENGAGEMENT.com&img=URL_OF_IMAGE_ENGAGED&method=ENGAGEMENT_METHOD&h=HEIGHT_OF_IMAGE&w=WIDTH_OF_IMAGE&full=FULL_URL_OF_ENGAGEMENT

In this example, ENDPOINT.COM is the domain where the webserver array resides, HANDLER is an endpoint for the array, COOKIE_ID is a unique user ID, CLIENT_ID is an ID of the client, SITE_OF_ENGAGEMENT is the domain and subdomain of the site where the user engaged with the image where an example site might be abc.example.com, URL_OF_IMAGE_ENGAGED_WITH is the full URL to the image that the user engaged with, ENGAGEMENT_METHOD is means by which the user engaged with the image such as sharing to FACEBOOK or sharing and image to PINTEREST, HEIGHT_OF_IMAGE and WIDTH_OF_IMAGE are the height and width of the image, respectively, and FULL_URL_OF_ENGAGEMENT is the full URL where the engagement happened such as http://abc.example.com/x/y?z. Upon completion of communication regarding the request of a specially formatted pixel as well as collection of image engagement data between a user's web browser and a web server 406, the collected image engagement data and associated images are passed to a central processing engine 402. The central processing engine 402 compares fingerprints of the new images against image fingerprints previously stored in a database 404, and then stores new image information in the database.

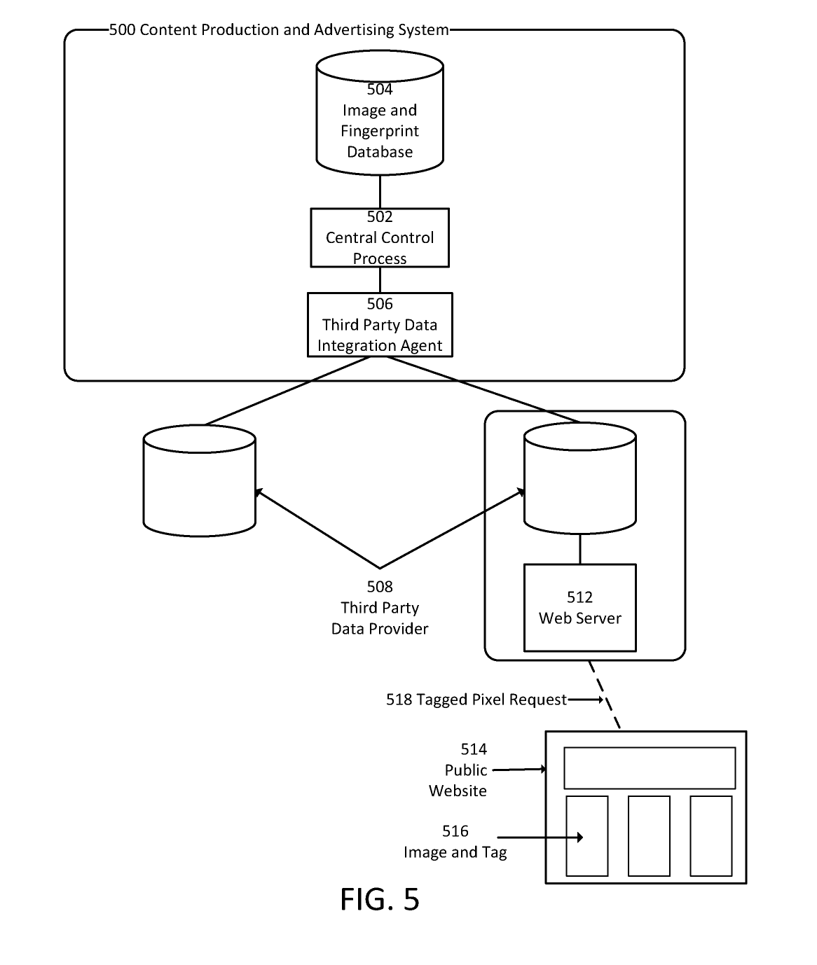

In further embodiments, a third-party data provider interface agent 506 communicates with various third-party data providers 508 to collect information from those data brokers about websites where branded images are shared as well as information about the audiences that have engaged and shared branded image. Example activities performed by third-party data providers include building databases of anonymous audience, demographic, shopping, and consumer interest data based on the placement of cookies in web browsers. While FIG. 5 shows only two third-party data providers to which the system is integrated, there is no limit to the number of third-party data provider integrations that are possible. Examples of such third party data providers include Quantcast Corporation of San Francisco, Calif., eXelate of New York, N.Y., TARGUSinfo of Vienna, Va., and others.

An exemplary data provider may broker an agreement to have a pixel 516 placed on a variety of wedding-centric websites 514. Each time such a pixel is called by the web browser, a data provider records the ID associated with a particular browser. If an aforementioned data provider identifies enough wedding-related activity within a particular time window associated with a given ID, a consumer may be identified as having a high likelihood of being an “in-market bride” who is shopping for wedding related goods. In some embodiments, specialized pixels 516 sent to a user's web browser based on the presence of appropriately tagged images within a consumer's current web page may redirect to a third party data provider. In some embodiments, a third party data provider receives this pixel request 518 at its own web server 512, identifies audience data for a particular consumer, and redirects the pixel request either back to the server that made the request or to another server that will allow the consumer's image engagement activity to be correlated with audience and demographic data. Data collected by a third party data provider is stored in its own database 508 which can be retrieved by a third party data interface agent 506.

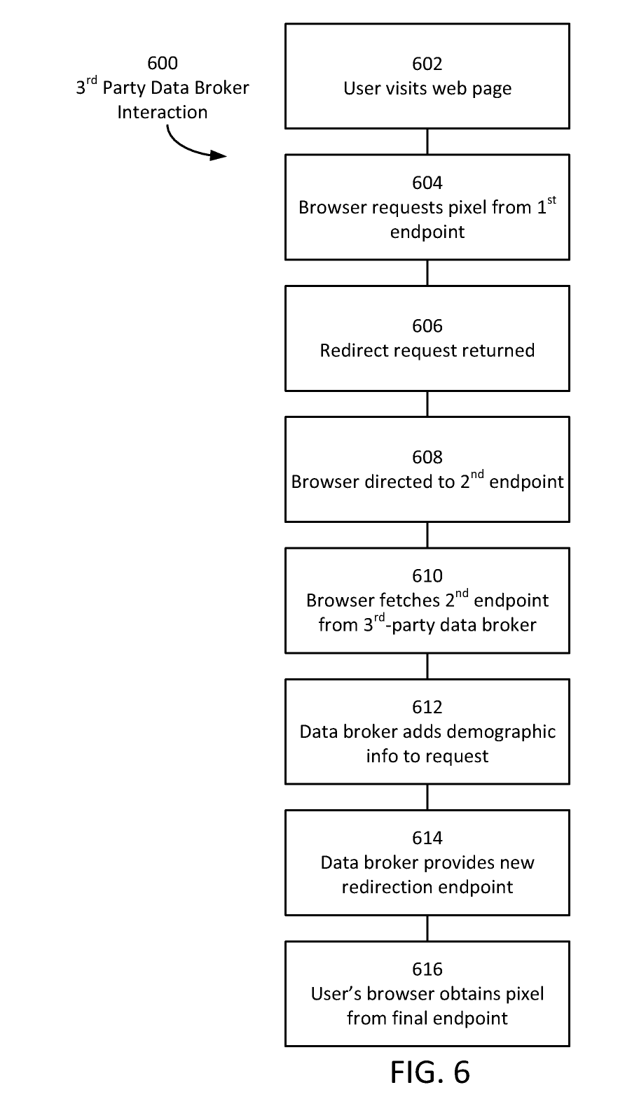

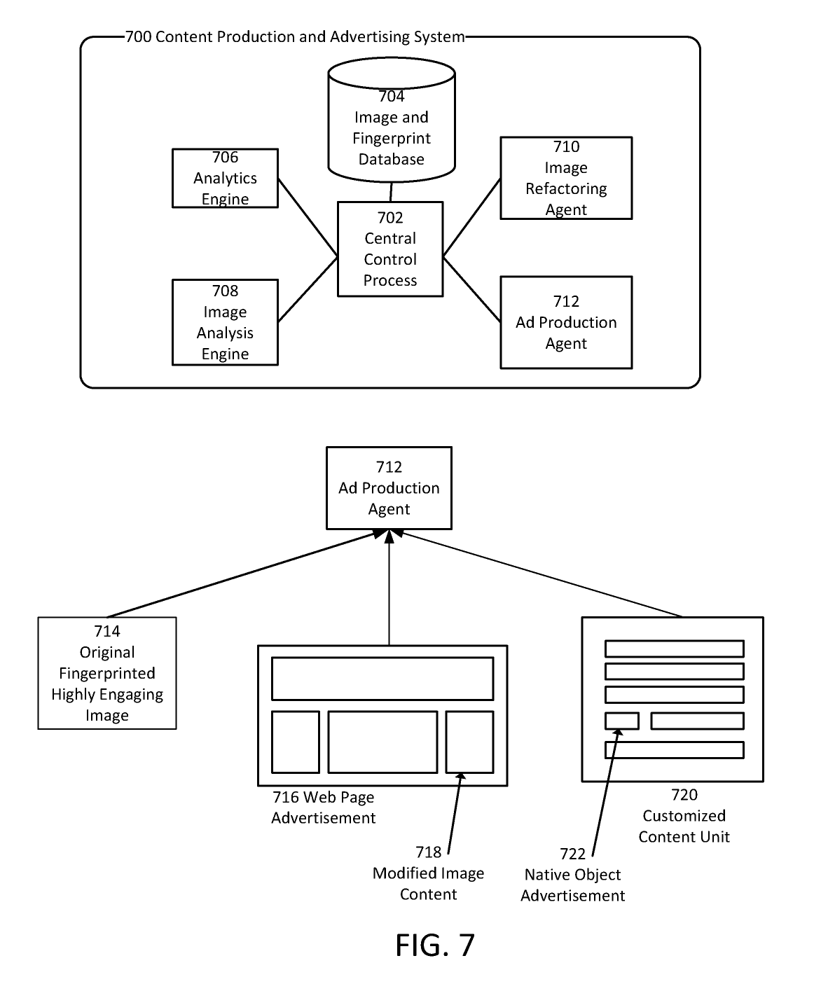

FIG. 6 presents an example dataflow for interaction with a third party data provider. In step 602, a consumer visits a web page that will host a fingerprinted image. In act 604, a consumer's browser attempts to fetch a pixel from an initial endpoint. Proceeding to step 606, a redirect request, such as an HTTP 302 response, is sent from a web server hosting the web site to the browser in place of the requested pixel. An example of such a redirect request is the following: http://DATAPROVIDER.COM/PIXEL?redir=http://ENDPOINT.COM/WITH_DATA?QS1&data=

In step 608, the redirect request directs the browser to fetch content from a second endpoint. The redirect request, as referenced above, contains an additional parameter “redir=” which informs the browser to where it should redirect, which in this case is to a site hosted by a third party data provider. Proceeding to step 610, the aforementioned browser fetches the second endpoint. Proceeding to step 612 in FIG. 6, the data broker identifies the consumer and represents the audience and demographics of the consumer according to its internal standards. Proceeding to step 614 in FIG. 6, the third party data provider issues another redirect in which it populates a new endpoint location to which it will redirect this request using the assigned “redir=” parameter and also appends a “data=” value to the request representing the consumer demographic data and other information it stores in its own database. An example third party data provider might utilize a series of integers to represent a particular demographic grouping to which it has assigned a current consumer, as follows: http://ENDPOINT.COM/WITH_DATA?QS1&data=1,2,3,4,5

Proceeding to step 616 in FIG. 6, the consumer's browser redirects to this final endpoint. In the particular redirection example above, the browser fetches the WITH_DATA services at ENDPOINT.COM, specifying the original query string, indicated here by QS1, and additionally includes the data from the data provider. In the aggregate, over all sharing activity, the propensities of various demographics to share or engage various different types of content can be identified.

In further embodiments, an image engagement analysis engine 708 performs analytics on the data that has previously been collected in database 704 to determine which of brand's images have been most shared, most engaged, or otherwise most resonant with a particular audience. In some embodiments, based on the choice of images made by the image engagement analysis engine 708, an image refactoring agent 710 creates new advertisements targeted to a particular audience. In further embodiments, to meet the requirements of new advertising locations that may be different from previously used locations, an image refactoring agent 710 may either use images as they exist originally or may need to modify the original image content to fit within a richer advertising experience.

In some embodiments, content produced by an image refactoring agent 710 creates customized content units with highly engaging content that may be used for native advertising or editorial purposes. In some embodiments, advertising units have slots for images of a certain width to height ratio, and because a brand's stock images may not necessarily match such ratios, an image refactoring agent may need to adjust images to ensure they are cropped appropriately. As an exemplary embodiment, an image is analyzed for bodies or faces, and if an appropriate object is found, the target ratio is analyzed in light of the position of the object in an image. An image is cropped to ensure that a top most object, such as a face, is not cut. By programmatically determining all of the edges and salient features within an image, an overall image center is determined for a given target ratio. In some embodiments, based on the ratio of the target image size and the ratio of the original image size, an image refactoring agent 710 determines an ideal cropping to maximize the amount of the original image shown as well as focus on the correct part of the image to be shown in a new advertisement.

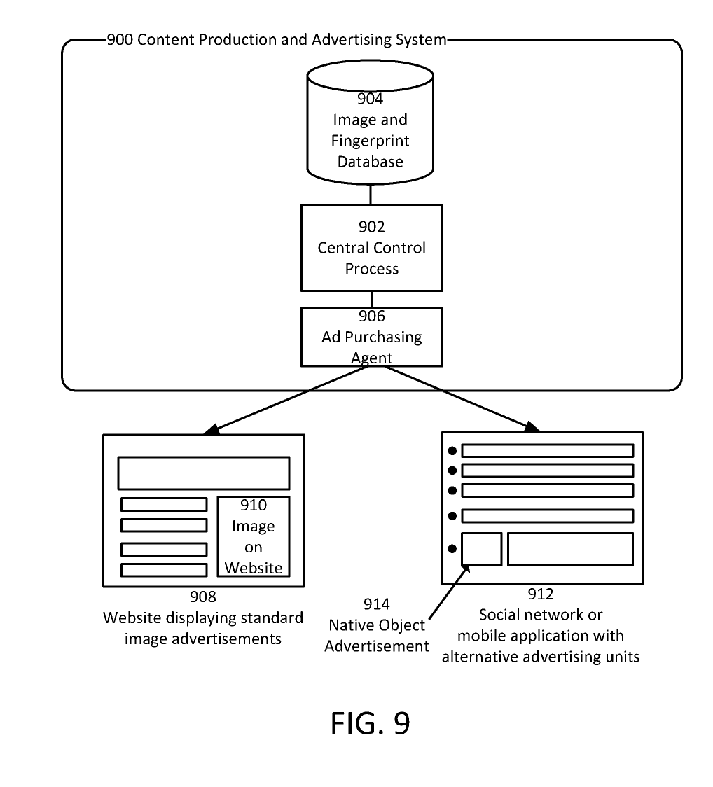

In an example embodiment, the advertisement production agent 712 dynamically or periodically creates display advertising units featured the most engaging images as determined by the image analysis engine 708. Display advertising units may consist of a template specifying how such images might be placed in the display advertisement, as well as animation between such images. In some embodiments, a template may include a configurable set of formatted frames, where formatting of frames might occur in an automated manner. In other embodiments, the formatting of frames might be performed in an offline setting. Additional formatting for such template may be specified, such as background color, logos, other images, etc. Such display advertising may be purchased by the ad purchasing and placement agent 906 discussed below with respect to FIG. 9.

Brands are thus assured of relevant, highly-engaging content in their display advertising without needing to create new creative content outside of what the brand is already creating. In other embodiments, brands or agencies might be able to choose from a library of preformatted set of templates stored by the advertisement production agent 712 for delivery as part of an advertising campaign. In further embodiments, brands or agencies may be able to upload their own constructed templates to an advertisement production agent 712 for delivery as part of an advertising campaign. In one example, an agency designs a template to be used as part of a banner ad for a current season's fashion campaign, having designed the main color scheme, logos, and background layout of the banner that are consistent with the main theme of the ad campaign. After selecting the template, the images to be utilized in a particular display of the banner ad, such as models wearing items from the brand's season collection, are pulled from the content production and advertising system 100 in a dynamic manner based on an image valuation process, described in more detail below, or from a preset stock of images for the that campaign. The valuation process for selecting images in a particular instance might be based on availability of displayed items for purchase at a particular moment in time, as well as other various consumer engagement metrics described in more detail below.

As an example of a resizing request performed by an image refactoring agent, if an original image is 300×300 pixels, and a target output image is 100×50 pixels, the original image will be reduced to 100×100 pixels and then cropped to 100×50 pixels. Any cropping performed on an image will be determined by features passed in the associated query string. As an example of the cropping process, if the focus of an image is passed as the 2^{nd} pixel from the top and 2^{nd} pixel from the left, then the resized output will ensure that this region is included in the output image.

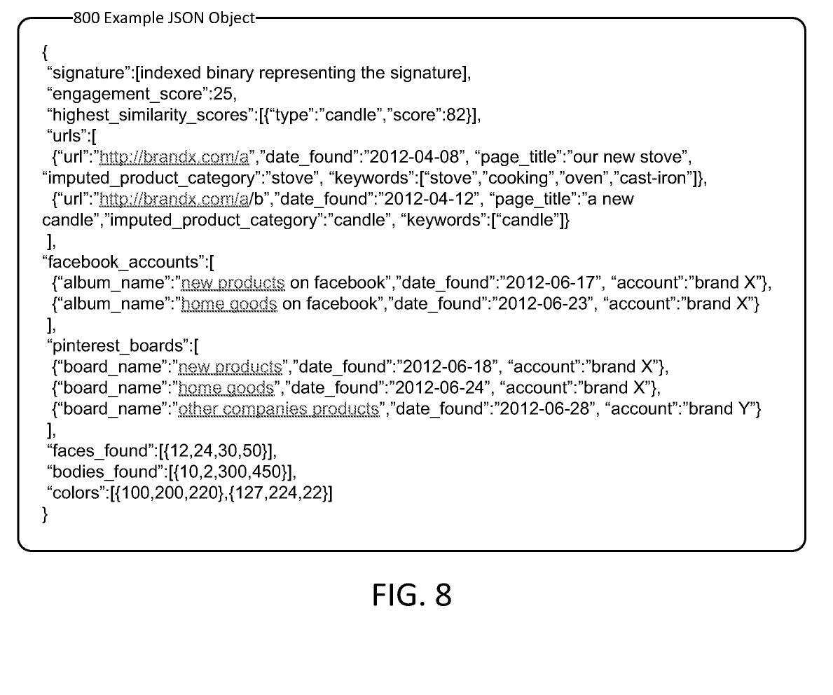

In further embodiments, newly created advertisements include social network API or other functionality that allow consumers to share easily that newly created content within their own social networks. As the newly created advertisements are created using material that was previously determined to be highly engaging, a feedback loop is enabled for the creation of new content by utilizing mechanisms for measuring user engagement that are discussed in more detail below in relation to image valuation. In some embodiments, ensuring that presented images are consistent and on-message with a brand's desired goals, such as promoting a particular product or category, placement of new advertisements by an ad placement and purchasing agent 906 may be assisted by using pattern matching in the URLs of the pages on which fingerprinted images are found, text analysis on the associated landing page, color detection on the associated page, image recognition on the associated page, and other identification techniques. In a sample embodiment, a brand may want to promote only women's shoes. Using a combination of regular expressions for the URLs (matching only those URLs that contain “women”) for example, with text analysis from the landing pages (matching only those pages that include “shoes” in the HTML), only those images that appear on the matched set of URLs will be selected. In further embodiments, various filters may be applied to ensure that only images associated with a particular brand, sub-brand, or campaign appear in a given advertisement. Since each image is de-duplicated when stored in the image database, various image locations may be determined based on both a plurality of URLs and a plurality of social networks. As an example of a means for tracking where a particular fingerprinted image has been found, FIG. 8 depicts a JSON object data structure that includes information stored about a particular image including various URLs and social networks on which an image was found, as well as salient features about an image such as various bodies, faces, and colors present within an image. In some embodiments, filters may be applied to an image's metadata to ensure that an image which appeared on a particular domain, subdomain, or any part of a social network is of a brand's particular product type or line. In further embodiments, a source in which an image appears may be used to verify the owner, as well as cross-reference against license information for pre-determined images or methods. As an exemplary embodiment, placement of an advertisement showing only shoes with the highest engagement, images chosen for a new advertisement may be limited to high-engagement visuals that were found on URLs matching “shoe” or other related words related to shoes, such as “high-heels”, or contained images that are programmatically determined to resemble shoes through the use of Haar classifiers or other techniques.

As shown in FIG. 9, in further embodiments, an ad placement and purchasing agent 906 makes decisions regarding appropriate websites on which to place advertisements using methods such as overlap and lookalike analysis. For example, by finding salient characteristics of an audience that engages with a brands images, and by determining the sites on which users with these characteristics over-index, website selection may be improvement. Using either real-time ad buying through a network such as DoubleClick Ad Exchange from Google, Inc. of Mountain View, Calif., AppNexus of New York, N.Y., or other means of purchasing advertising inventory, an ad placement and purchasing agent 906 will deliver newly created advertising content 910 to appropriate websites 908. In some embodiments, an ad placement and purchasing agent 906 will choose to deliver alternative advertisement units 914 for native advertising within social networks, other websites, or mobile applications that integrate alternative advertising units 912 including native objects instead of display advertising. As an example of customized content units, automated posts to FACEBOOK may be produced using content determined to be highly engaged from across the web, from FACEBOOK itself, or from a combination of other sources that were combined using various image signatures. Such posts may then be promoted using a paid audience expansion through Facebook's native advertisement technology. In another example, TUMBLR posts with content previously deemed to be highly engaging and formatted appropriately for TUMBLR may be automatically posted and amplified using TUMBLR's native advertising solution. Examples of other possible advertisement delivery formats include changing a website's background to include highly engaging content, changing a brand's TWITTER background to include highly engaging content, as well as a many other potential delivery vehicles.

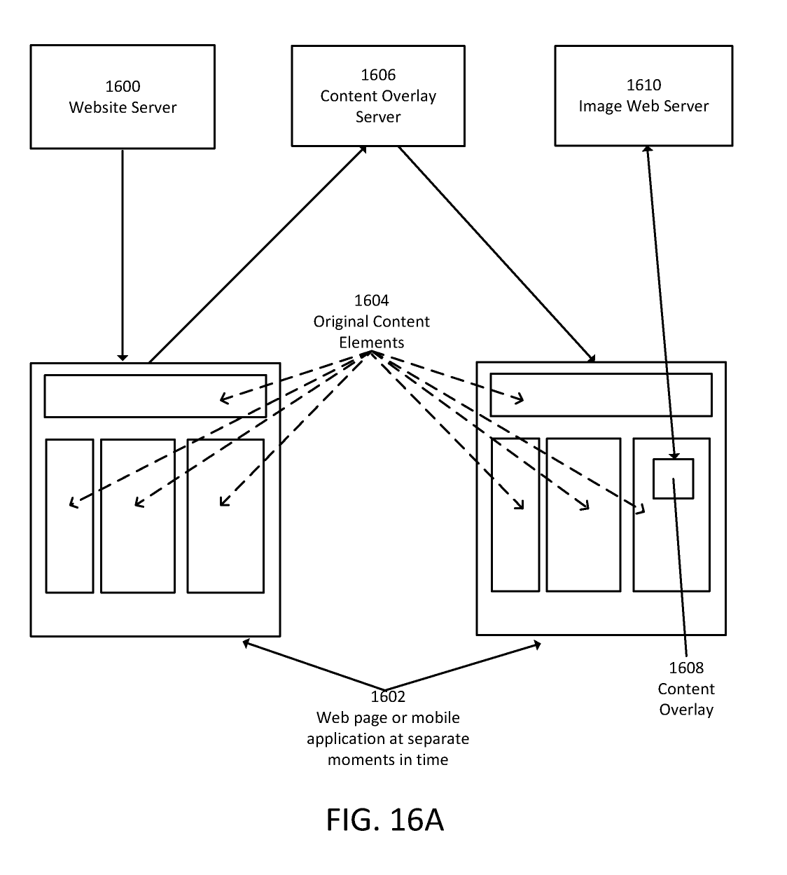

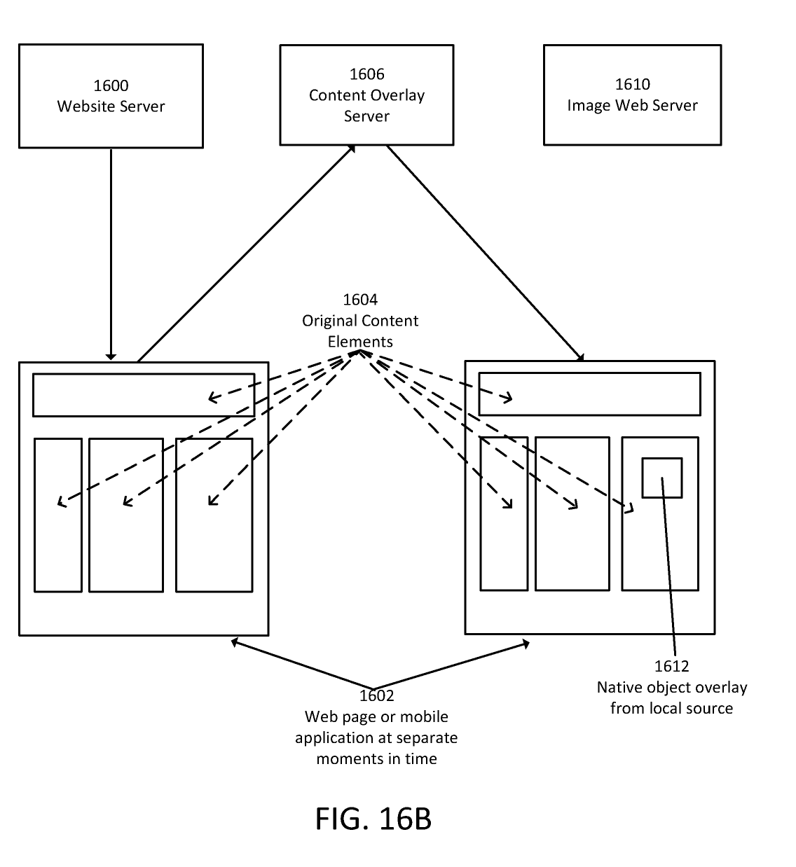

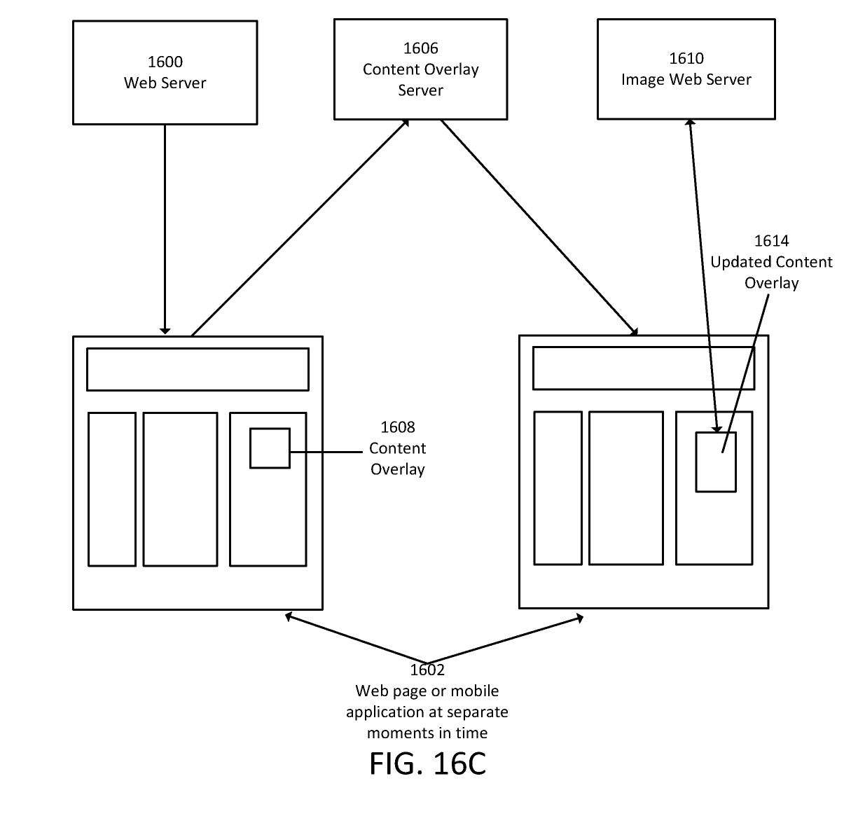

As shown in FIG. 16A, in some embodiments, a web server 1600 serves content elements 1604 to a web page or mobile application 1602 that is presented on a consumer's web browser or mobile device. In some embodiments, to obtain these content elements, a web browser makes requests for content to at least one and possibly many web servers with the returned content comprising the displayed composition of the web site. In some embodiments, a web browser or mobile device stores a representation of the web page or mobile application 1602 in memory of the computer on which the browser or mobile application is executing. The browser renders the representation of the web page either as it is being loaded or when it has completed loading.

In some embodiments, at least one of the responses for content from a web server 1600 delivers instruction code that directs the website to obtain additional content from a content overlay server 1606 hosted as part of a content production and advertising system. The content overlay server 1606 receives the request for additional content from the webpage 1602. The content overlay server 1606 then delivers instruction code to the browser executing the web page 1602 that directs the browser to find at least one element in the web page or mobile application 1602 from the representation of that web page held in memory as well as the visual presentation of that page. In some embodiments, identification of such an element might be based on location of an element on the page, size of an element, or other identifiable document attributes. In some embodiments, upon identification of an element by the browser, the code received by the browser may analyze the underlying content of the element and may combine information about the element with data about the user, time of day data, and other sources of data into a packaged message. In some embodiments, information may also be added to the message about the element that allow for further identification of that element by subsequent messages received by the browser.

In some embodiments, the packaged message may be sent from the browser mobile device hosting web site or mobile application 1602 to the content overlay server 1606 that requests appropriate overlay content 1608 to be delivered to the web page or mobile application 1602. In other embodiments, the packaged message may be sent to a separate image web server 1610 that hosts an image to be used for overlay content 1608. In some embodiments, an image engagement analysis and image valuation process, such as the image valuation process described below, is executed to determine an appropriate image for use within a content overlay 1608.

In some embodiments, a tag to be used for content overlay 1608 is returned to the web browser and is placed appropriately on the web page as content overlay 1608. In some embodiments, a tag is associated with an image, and as a consumer engages with that image used as content overlay 1608, image engagement data related to that tagged image is collected from the web browser as described previously above. In some embodiments, the tag is associated with new social content allows for a consumer to share the images that are present in the advertisement with members of a social network. Examples of overlaid content include the addition of a “like”, “re-pin”, “re-tweet”, or other button that is stored as a native object and is overlaid on an image or web page allowing a user to share the underlying image or web page. In some embodiments the native object to be used for content overlay might be pulled from a remote source, such as a content overlay server 1606, image web server 1610, or social network server.

As shown in FIG. 16B, in other embodiments, a local copy of a native object 1612 to be used as a content overlay might already be present on the computer that is executing a native application, and does not need to be fetched from a remote location. As an example of a pre-existing native object used for content overlay, a mobile application might pre-install various native objects, such as “like”, “share”, “comment”, or other functionality that connects to social networks. These pre-installed native objects can be used as content overlay when their native object identifiers are associated with an appropriate tracking tags provided with the content overlay.

In some embodiments, an overlay may be presented in the same browser window as the original web page. In other embodiments, the overlay may be presented in a pop-up window or new browser window. As an example of a content overlay pop-up window, a consumer may click on a portion of an advertisement that has been overlaid, triggering the appearance of a comment pop-up window. The consumer then has the ability to enter text into a comment box pop-up window associated with that bit of content, and share that comment with members of a social network upon submitting the comment.

As shown in FIG. 16C, in some embodiments, when a consumer interacts with the initially overlaid content, further requests for overlaid content may be sent to the content overlay server 1606. Responses to subsequent requests that pull images from either the content overlay server 1606 or a separate image server 1610 provide new material for the display of updated overlay content 1614. The ability to update the overlay content dynamically allows the consumer to have a rich interaction experience with overlaid content that was not present in the original content elements 1604 from FIG. 16A of the web page or mobile application 1602 and does not require modification of that original content. As an example, if the underlying original content is an advertisement, the overlay code sent to the browser detects the advertisement and provides details of each element of clothing in the advertisement when the consumer clicks on an overlay, then any article of clothing could be changed by style, color, item, or other representation by sending an appropriate message to the ad production agent 1608 and then returning the appropriate item to replace in the updated overlay 1614. Through the interaction with potentially multiple image servers and third party sites, additional revenue might be generated for the component on which the content was overlaid. As a further example, the addition of content within a social network normally requires the changing of a creative element displayed within an image. By adding the appropriate tag to the delivered overlay message, the overlay can include appropriate connectors to social network APIs requesting content that is targeted for a specific user. The delivery and tracking of these tags embedded with the overlay content is similar to the discussion of tagged pixels discussed previously. In some embodiments, the choice of overlaid content may depend on analysis performed on the context of the web page, demographic information obtained about the viewing consumer, location of the consumer, time of day, time of year, and many other factors.

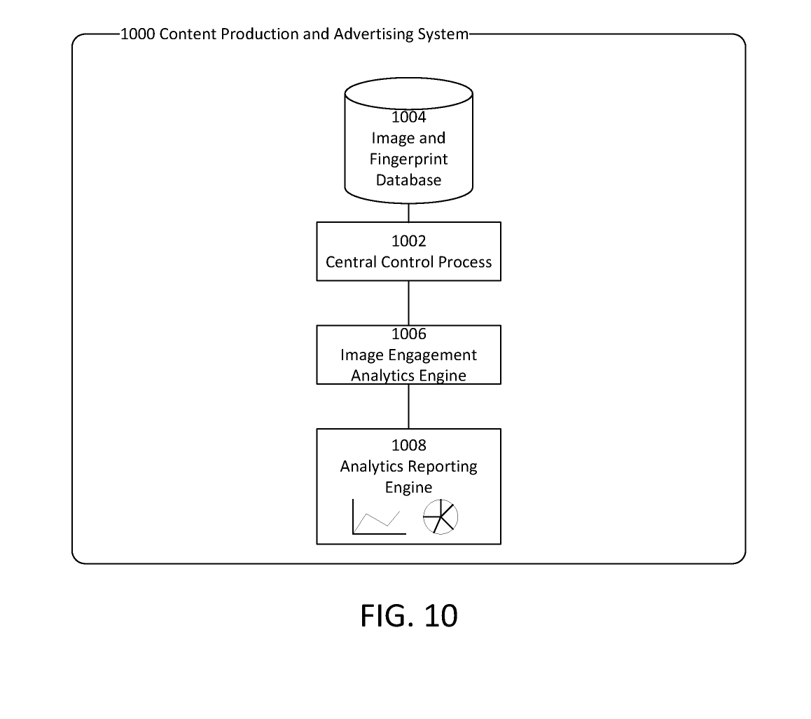

In further embodiments, as shown in FIG. 10 a central control process 1002 instructs an image engagement analysis engine 1006 accesses image data and metadata stored in a database 1004 as well as feedback from various external integration sources to produce image engagement analytics 1008. In some embodiments, data is analyzed on a number of attributes including audience demographics, image viewing context, and numerous other factors. Results of image engagement analysis are then used to inform a brand or its agents regarding the type of content that is most shared and engaged by various audience types. A brand or its agents can use this knowledge to inform future content production, media buys, editorial decisions and other issues relevant to the operation of its business. In some embodiments, an image engagement analysis engine cross-correlates sharing from advertising units with general consumer sharing and normalizes the impact that any advertising may have on overall sharing behavior to avoid distortion of data.

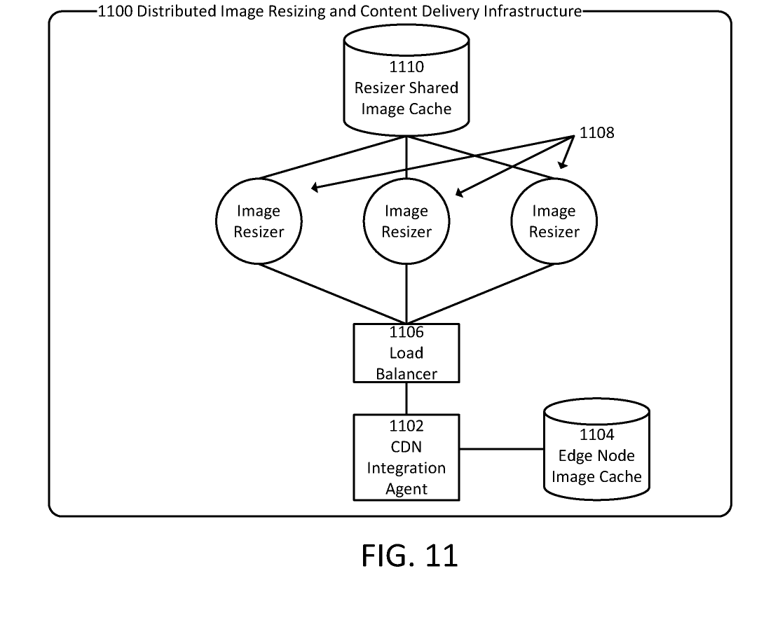

In some embodiments, the image resizing functionality for all images that might possibly be resized is implemented in a distributed fashion across more than one computer system, as shown in FIG. 11. A cluster of dynamic image resizers 1108 is situated behind a load balancer 1106. A request for a particular image is made from a public website or social network and is first received by a content delivery network endpoint 1102 located at the edge of a content delivery network. If this exact request has been made previously, and was saved within a predefined retention period, then the image required will be stored within an edge node image cache 1104. Consequently, the image is distributed with very low latency. If the request is not found in the edge node image cache, then the request is passed along to a load balancer 1106, which in turn passes the request to one image resizing process in a cluster of image resizers 1108. In some embodiments, a request will include information including the original image, the desired output size, instructions for focal points of the input image, possible rotations, a decision regarding whether to crop an original image to ensure an image fits in a required output space, a decision on color to use for fill if an original uncropped image does not fit in a required output space, locations of bodies or faces, as well as other image metadata. A request may also include details about a particular logo to be overlaid on the image, as well as where to place the logo on the image. Upon receiving a request with all pertinent data and metadata related to an image and the requirements for its resizing, an image resizer 1108 finds an image and manipulates it accordingly. Unless explicitly set otherwise by the requirements provided in a query string for a particular image request, the main goal in the image manipulation process is to include the maximum amount of an original image possible, and the optimal region of the original image within the output image that is produced.

In some embodiments, any resized image that is produced will be stored on a shared image cache 1110 that is accessible to all image resizers 1108. Any image resizer in a cluster of image resizers 1108 will first check with the cache 1110 for the output image for all query strings it receives before manipulating an image. If an image resizer in the cluster of image resizers 1108 finds an image on the cache 1110 that matches a query string for a particular request that has been received, then the image resizer will return to the content delivery network integration agent a copy of the existing image. Use of an existing image that meets the requirements of a received query string provides for more efficient distribution of images to all edges of a content delivery network.

In some embodiments, whether an image is retrieved from an image resizer shared image cache 1110 or is newly created by an image resizer 1108, the image will be returned to a content delivery network integration agent 1102 located at the edge of a content delivery network, and will be stored in an edge node image cache 1104. Once delivered to the content delivery network integration agent 1102, an image will be distributed though the content delivery network to the end user that placed the original image request. In some embodiments, an edge node image cache 1104 may include an expiration parameter that provides for the deletion of content after a predefined retention period has passed. For example, if an edge node is set to retain all images for one day, then any image stored on an edge node that has not been requested during the previous 24 hours will be deleted from the edge node. In further embodiments, a database may be maintained that stores image content and associated requests for that image content. Any low activity content that has not been requested during a threshold period or has not been requested as often as other content can be deleted from the edge node images caches after a set time interval or when additional space is required on the machine where an edge node image cache is being maintained.

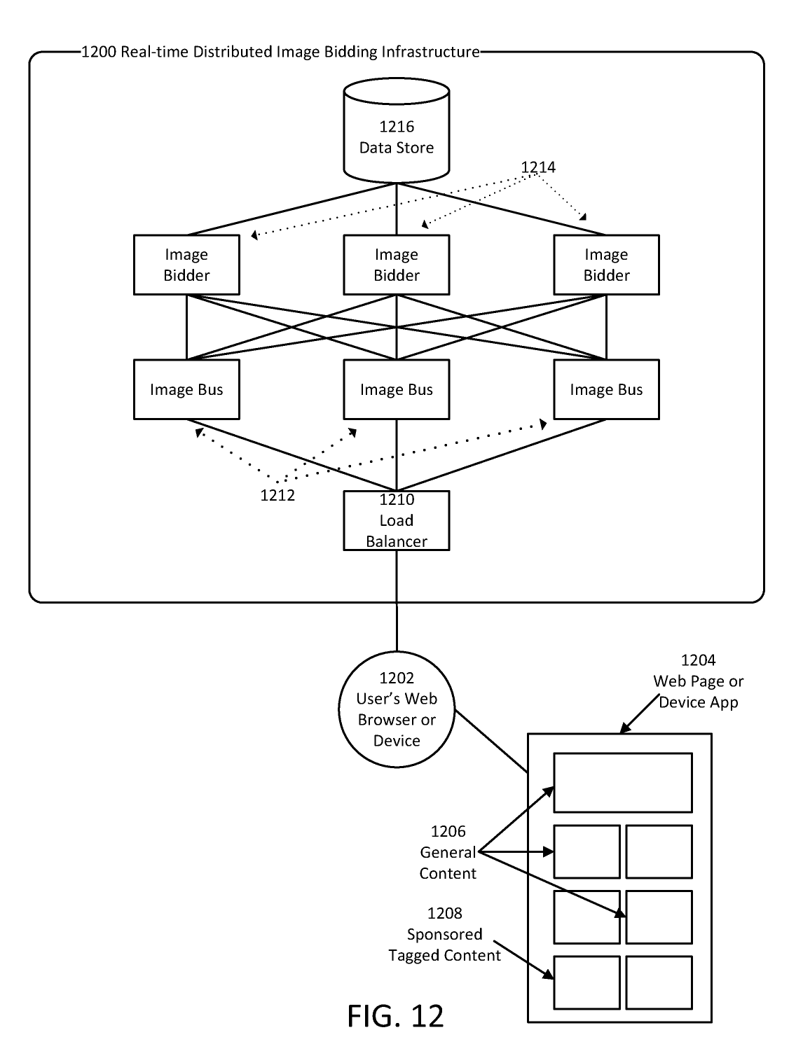

In further embodiments, a real-time image bidding infrastructure is used for determining the most appropriate image to provide to a user based on an image request that has been received. In some embodiments, a real-time image bidding infrastructure is implemented in a distributed manner across multiple computer systems, as shown in FIG. 12.

When a consumer's computing device or mobile device 1202, such as a mobile smartphone, executes a program capable of connecting to the internet and requests a particular set of content 1204, the publisher of that web page or application returns code to the device that initiated the request. This code generally returns various blocks of general content 1206, and can additionally include a tag for a particular portion of the returned object that directs the user's device to fetch sponsored content 1208 to be displayed. The device 1202 initiates a subsequent request to an endpoint that may be a load balancer 1210 or a single web server. In some embodiments, a tag returned by the publisher of the website or application may include various parameters, such as required category, colors, dimensions, whether to return a native object, HTML object, javascript or other web object, target width and height, whether full-body models are required, whether certain brands or content verticals are excluded, and whether human audits of the returned images are required. In some embodiments, these requirements may be entered into a console and are not required as part of a received query string. Identification of a particular tag would thus correspond to the settings required for that tag, but can be overridden by received parameters within a query string.

In some embodiments, a decision on whether or not a returned object associated with a tag should be a native object depends on the nature of the web page or application in which the object is being presented. As described above, a native object describes whether the object returned is generic code to be rendered by a browser or similar program, or if the object returned is formatted such that an executing program can identify the returned code as belonging to its own taxonomy, and parse and render the underlying content accordingly. For example, if a mobile fashion application has its own data structure of outfits, in which each outfit has a particular ID, and users can “heart” or “comment” on outfits within the mobile application, a native object would instruct the fashion application to render a particular outfit as defined within its internal taxonomy. This taxonomy would need to be synced such that the ID of the outfit in the mobile application's taxonomy is known to the party returning the ID of the outfit. Thus, if brand X is paying for promoted content, and brand X is featured in outfit Y, returning the ID of outfit Y to be rendered by the mobile application would be returning a native object. As an example, if a tag requires fashion images, and its associated content is to appear on a fashion-centric application, returning a native object allows the application to process a response as part of a core function within the application, which allows users to engage with the delivered image content in the manner most natural for that application. Examples of such natural interaction include “heart”-ing or “like”-ing image content, saving the content to their profile within the application, commenting on the content, all within the context of the particular application being utilized. Native interaction is especially valuable in a mobile device context where users are less likely to switch off from a particular site or application, but may be inclined to interactive natively with an image within the context of a currently viewed application.

In some embodiments, a tag returned to the user's device 1202 directs a request for content to a load balancer 1210. As explained previously, parameters included in such a request might include information such as a current user's ID, the particular tag involved, the web page or mobile application in which the content is to be displayed, as well as other information. In some embodiments, a load balancer 1210 directs requests to an image bus process 1212 that is part of a cluster of image bus processes that may exist on one or more computer systems as part of a cluster of computer systems. An image bus process 1212 parses a request received from a load balancer 1210, sends the parsed request to one or all eligible image bidder 1214 processes from a cluster of image bidder processes that may exist on one or more computer systems as part of a cluster of computer systems. Upon receipt of requests from an image bus process 1212, the image bidders 1214 perform a valuation process, to be discussed in more detail below, in order to determine which images are best returned to an image bus process 1212 for responding to the original image request. Upon receiving a response from various bidders, which may include multiple image valuations for a particular bidder, an image bus process 1212 selects the top choice, formats the image appropriately, (including rendering as a native object, when appropriate) potentially defining the parameters to be used by an image refactoring agent 110 as discussed in FIG. 1, and then returns a response to the request.

As an exemplary embodiment of the distributed image bidding system, the valuation process performed by the image bidders is separated on to different machines from the other parts of the overall system architecture. The valuation process, as described below, is a very CPU-intensive activity in which an effective valuation of all eligible images must be calculated as quickly as possible. The overall bidding system, consisting of a cluster of individual bidders, requires a highly optimized architecture to create and store all necessary valuation metrics.

In some embodiments, a load balancer's 1210 choice to direct a request to a particular image bus machine 1212 may be based on attributes in the request, attributes of the consumer's current location, a round-robin ordering sequence, or other possible factors. As an example, if there are numerous geographically distinct data centers in which the image bus machines reside, choosing the data center geographically closest to the user will result in reduced latency. As a second example, if a user is located in a particular country, the laws of that particular nation may require that data always reside in that particular country or may require different privacy standards for the handling of data, in which case a request may be directed to an image bus machine within that user's current country.

In further embodiments, a tag may be configured to accept or reject certain brand images, ratios of images, categories of images, whether the response type is a native object, the formatting of a native object, and other possible configurations. In some embodiments, the information associated with the tag may be stored by either an image bus process 1212 on the machine where it is executing or by an image bidder machine 1214 on the machine where it is executing. In further embodiments, an image bus machine parses and translates a request into an image bid request, which is sent to one or many image bidding processes 1214 executing on one or more distinct computer systems. A decision for which image bidding process to which a request is sent may be based on a variety of factors including the type of image being requested, for example the types of filters (such as eligible brands, categories, colors, etc.) that are being employed for that tag, the type of response required, such as whether a native object is required, a round robin assignment, or other factors. In some embodiments, a timer might be initiated in the image bidder that requires all responses to be returned within a certain time interval.

In further embodiments, upon receiving an image bid request, each image bidder 1214 calculates an effective valuation for various images to return. A particular effective valuation may depend on factors such as the valuation an advertiser places on various types of engagement metrics. Examples of engagement metrics include social engagement metrics, such as “re-pins”, “likes”, and “comments”, non-social advertisement engagements, such as click-through operations for banner ads, personal-use engagements, such as saving to local or remote storage locations or e-mailing image attachments. Further refinements of engagement metrics for each category include engagement to date on the tag in the request, the engagement to date on tags similar to the current tag, the current consumer's propensity to engage with image content, the recency and frequency with which a consumer has seen the particular image in question, the recency or frequency with which a consumer has seen images from the current brand, as well as other factors. Specific formulas for calculating an effective valuation vary, but the following formula provides an example of one such valuation:

$$bid = ( {r}_{b} {f}_{b} {t}_{b} {d}_{b} ) * CPC * ( {\sum }_{n} {e}_{n} {m}_{n} ) * ( {u}_{d} {t}_{d} ) * ɛ \qquad ( 1 )$$

where:
bid is the effective bid calculation,
r_{b} is the platform or tag-specific redundancy bucket, which is a modifier for a bid based on how recently a consumer has last seen this particular image or an image from this advertiser,
f_{b} is the platform or tag-specific frequency bucket, which is a modifier for a bid based on how often the user has last seen this particular image or image from this advertiser,
t_{b} is the platform or tag-specific time-of-day bucket, meaning how well the tag performs at a given time of the day,
dₚ is the platform or tag-specific day-of-week bucket, meaning how well the tag performs on a specific day of the week,
CPC is the effective cost per click that the advertiser is willing to pay,
eₙ is the engagement for a particular network, including the page on which the tag is called,
mₙ is a modifier for the engagement in which the engagement on such network n translates into performance for the advertiser,
u_{d} is the observed and/or calculate user disposition to engage with the advertiser's content,
t_{d} is the tag-specific disposition to perform for the advertiser's content,
ε is the error correction parameter.

In some embodiments, all data necessary for performing an effective valuation is stored within a data store 1216, from which each bidding process 1214 receives periodic updates. Bidding processes should not need to consult the central data store with each request. All eligible images are calculated and a certain number, which is at least one, of the highest valued images meeting the requirements of the current tag are returned to a requesting image bus 1212 along with their associated effective valuation. The requesting image bus 1212 collects all valuations that were returned within the set timeout period, which may come from several image bidders 1214, and then determines the best image for the current request. The choice for the image may be based on the highest effective valuation, a requirement to show certain images, or other factors. The chosen image is then formatted as appropriate. As an example of formatting that may be required, if a native object is to be returned for a request, then requirements about how to format the image, as well as any modifications required to alter the image into a native representation, such as the native object ID of the image, are performed. Once any required formatting is performed, either a native object, HTML, or other appropriately formatted response is returned to the consumer's device 1202.

In some embodiments, when an image call is returned to a consumer's device, it then makes a subsequent request to an image server such as described above in association with FIG. 11. A request for an image includes parameters such as target size and others previously discussed. An image server returns a requested image to the consumer's device 1202.

In some embodiments, a consumer's device 1202 may receive a call for a native object, in which case the device calls the server on which such a native object is stored. Native objects may be presented in a variety of manners. In some embodiments, a native object is represented as a call to an image presented in a native format such as the following example in JSON format:

{

“image_url”:http://URL_TO_IMAGE.com/a/b?c,

“hypothetical_parameter_1”:100,
“hypothetical_parameter_2”:200,
}

While this example includes two hypothetical parameters with various values, such formats may include any number of parameters and be formatted according to various specifications that a particular native format requires. As an alternative example, when the URL for an image is not specified, a native object may be returned in a JSON format such as the following:

{

“image_id”:123456,

“hypothetical_parameter_1”:100,
“hypothetical_parameter_2”:200,
}

For this example, the object ID on the platform to which the image object is returned is 123456. This value corresponds to a particular image, but this image is stored as a native object by the publisher. An offline process synchronizes native object IDs and image URLs. The specifications of the publisher's image format are defined within an internal data structure, possibly including appropriate mapping IDs, which are used to format the output as appropriate.

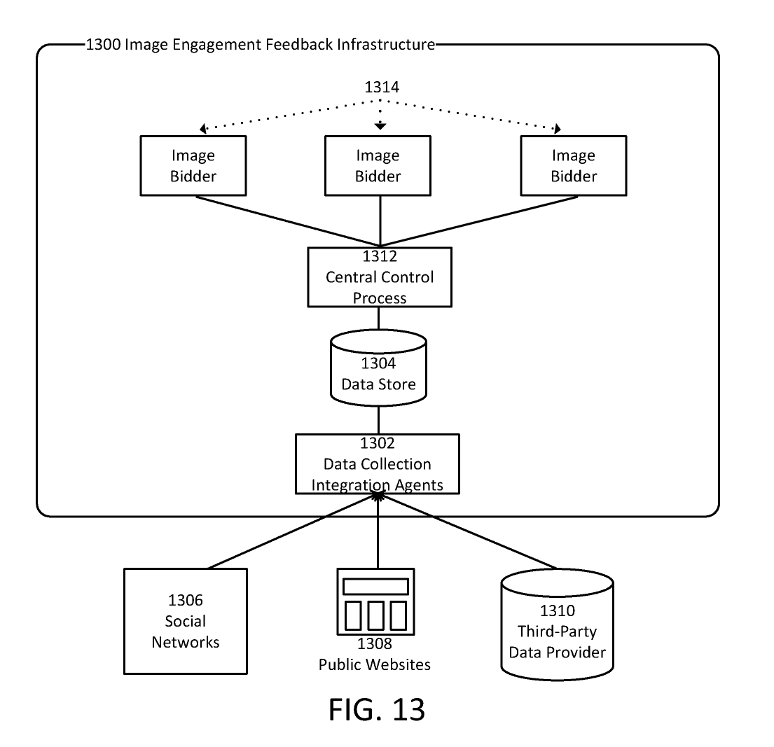

In further embodiments, various data collection integration agents 1302 such as social network integration agents 124, web crawlers 126, third-party data integration agents 128, and tagged pixel web servers 130 previously discussed in association with FIG. 1, are used to collect user engagement data from various social networks 1306, public websites 1308, and third-party data providers 1310 as represented in FIG. 13. The performance of native content that has been served by a dynamic image server as discussed in FIG. 12 is found by measuring the engagement appropriate for a particular platform be it a social network, public website, mobile application or other platform. For example, if the platform provides for a “like”, “heart”, or “re-pin” action, such metrics will be obtained from those platforms, stored in a data store 1304, and analyzed as one measure of performance for the image on that platform or for the associated tag. In some embodiments, a central control process 1312 aggregates such data from a data store 1304 and periodically updates each image bidder 1314 in a cluster of image bidders. Consequently, the valuations for future image bids as performed by various image bidders contain relevant 3^{rd}-party engagement metrics as part of a feedback loop.

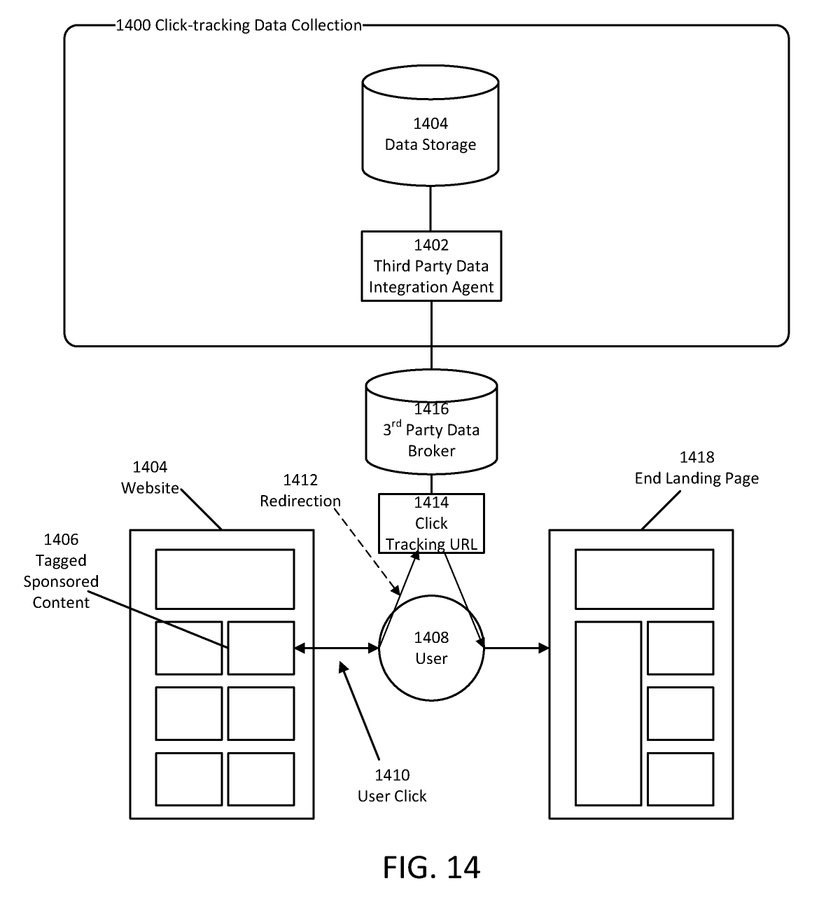

In further embodiments, when a user 1408 clicks 1410 on an image 1406 located on a website 1404 as shown in FIG. 14, where that image was delivered by a process to that process discussed above in association with FIG. 12, a click-through URL performs a redirection operation 1412 to a click tracking URL 1414. The click tracking URL stores information about the click, current advertising campaign, referring website, user, and other data in third party data storage 1416, and then redirects the user to an ultimate landing page 1418. This click data is aggregated along with the procedure discussed above in association with FIG. 13. Data for native content and images presented in within traditional public websites are combined to present an aggregated metric of performance for a given image, and is stored in data storage 1404. This performance data allows for optimization of placement across all media in line with advertising targets.

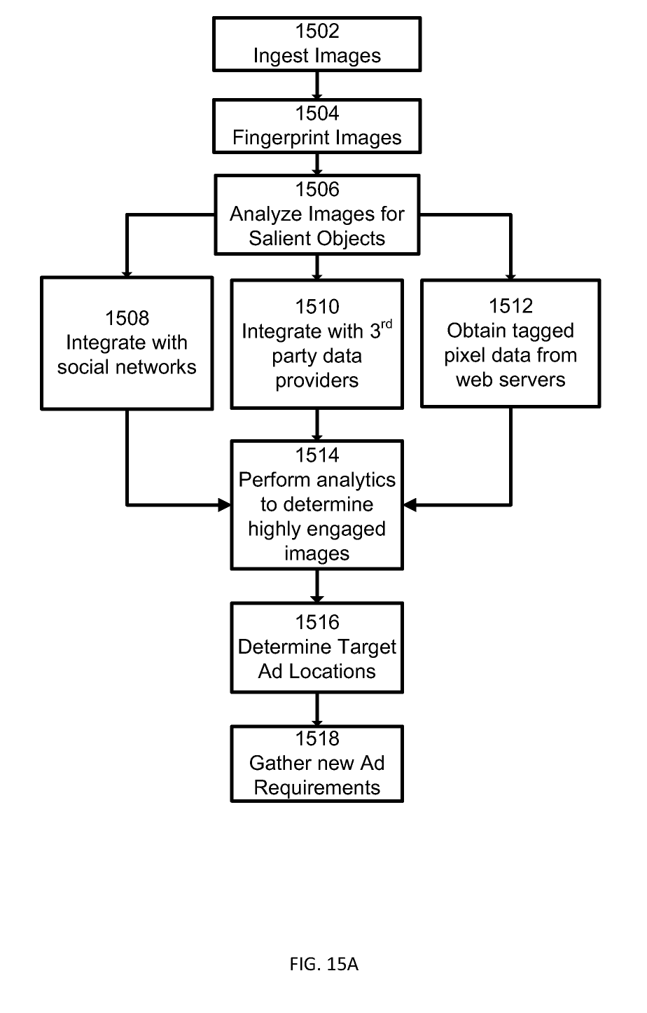

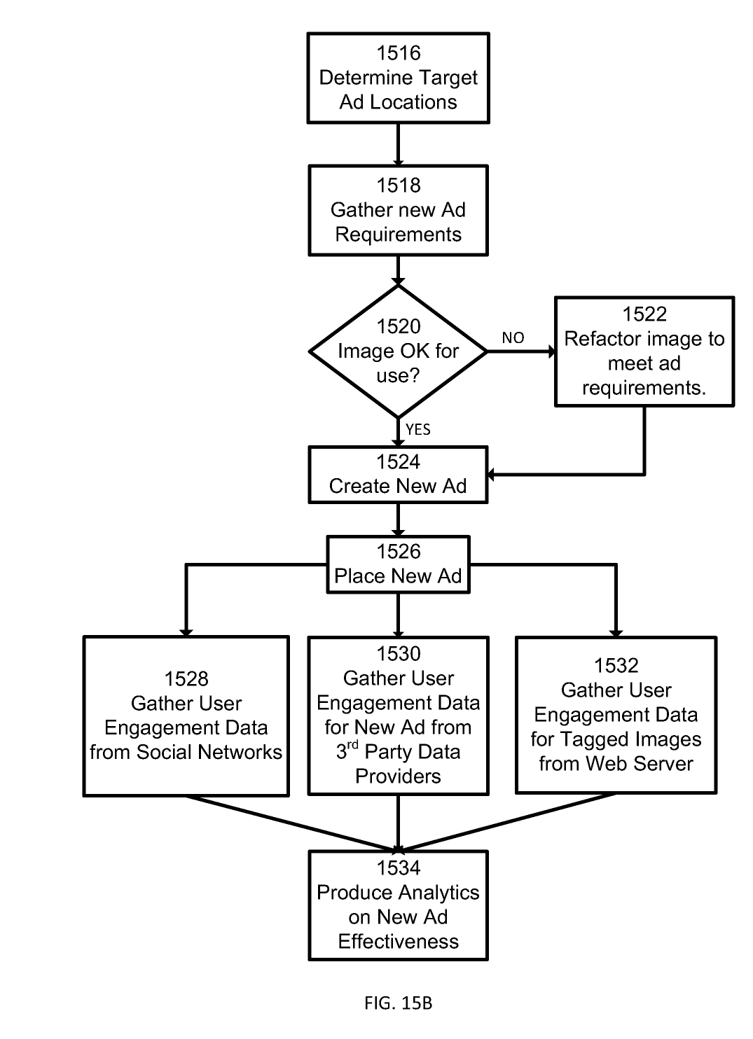

Having described many of the various sub-processes, FIG. 15A and FIG. 15B present an example overall workflow for the creation, measurement, delivery and amplification of digital image advertisements. In act 1502, images are ingested into the system using a web crawler such as 126 from FIG. 1, or through a manual upload of images to an image database 104 from FIG. 1.

In act 1504, a fingerprinting agent 106 performs a fingerprinting analysis of the ingested images using one of the fingerprinting methods described previously, and then stores the resulting fingerprints within the image and fingerprint database 104.

In act 1506, an image analysis engine 108 analyzes images stored in database 104 to determine salient features of the objects depicted within images stored in the database. Salient image features might include bodies, faces, and particular objects associated with brand. Having both fingerprinted and analyzed a base set of branded images, the system is ready to obtain and utilize information related to consumer image engagement with those images.

In acts 1508, 1510, and 1512, the image engagement analysis system integrates with various social networks 1508, third party data providers 1510, and web servers hosting tagged image pixels to obtain information on how consumers are engaging with branded image content.

In act 1514, an analytics engine 112 utilizes the collected consumer engagement data to determine the most highly engaged images. In some embodiments, the analytics engine may also rely upon calculations performed by various image bidder processes 116 as a factor in its own computations.

In act 1516, an advertisement purchasing and placement agent 122 determines the location where new advertisements should be placed based on the analysis performed by analytics engine 112, as well as requests received for images from various external integration components.

In act 1518, an advertisement production agent 120 gathers requirements for a new image based advertisement, and submits requests for an appropriate image to a load balancer such as 1106 in FIG. 11 to have an image supplied that meets the requirements of the target ad location. Based on the response, in act 1520, a decision is made based on the nature of the images available. In some embodiments, the creation of a new advertisement might involve the refactoring of an existing image. Refactoring an image in act 1522 might involve resizing, cropping, or overlaying new content designed to enhance user engagement, as described previously. In some embodiments, a required image meeting the needs of the advertisement will have been previously created, and can be returned immediately from either a permanent image database, such as image database 104, or a temporary cache node, such as an edge node 1104.

In act 1524, an advertisement production agent 120 uses the returned image to create a new advertisement that can then be delivered to a consumer.

In act 1526, an advertisement purchasing and placement agent places the newly created advertisement or delivers the appropriate image to a social network or a website using an interface to a content delivery network, such as the content delivery network integration agent 1102.

In some embodiments, once the new image based advertisement has been placed in its end location, new information regarding consumer image engagement with that image can be collected. Acts 1528, 1530, and 1532 depict an example of gathering new consumer image engagement data from social networks 134, third-party data providers 138 and web servers 130 that host tagged pixels associated with the new branded image.

In act 1534, an analytics engine, such as the analytics engine 112 in FIG. 1, collects the newly gathered consumer image engagement data and produces analytical results, such as those results shown in FIG. 10, by an analytics reporting engine 1008.

### Computer System

Various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems.

Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

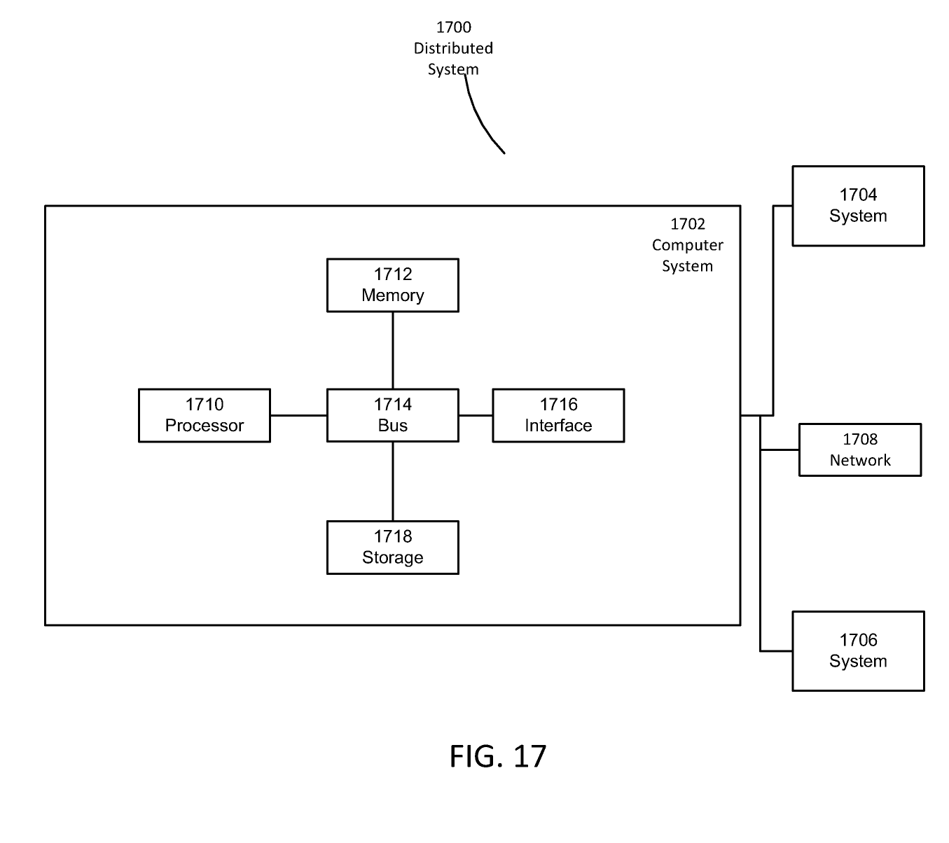

Referring to FIG. 17, there is illustrated a block diagram of a distributed computer system 1700, in which various aspects and functions are practiced. As shown, the distributed computer system 1700 includes one more computer systems that exchange information. More specifically, the distributed computer system 1700 includes computer systems 1702, 1704 and 1706. As shown, the computer systems 1702, 1704 and 1706 are interconnected by, and may exchange data through, a communication network 1708. The network 1708 may include any communication network through which computer systems may exchange data. To exchange data using the network 1708, the computer systems 1702, 1704 and 1706 and the network 1708 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 1702, 1704 and 1706 may transmit data via the network 1708 using a variety of security measures including, for example, TLS, SSL or VPN. While the distributed computer system 1700 illustrates three networked computer systems, the distributed computer system 1700 is not so limited and may include any number of computer systems and computing devices, networked using any medium and communication protocol.

As illustrated in FIG. 17, the computer system 1702 includes a processor 1710, a memory 1712, a bus 1714, an interface 1716 and data storage 1718. To implement at least some of the aspects, functions and processes disclosed herein, the processor 1710 performs a series of instructions that result in manipulated data. The processor 1710 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. The processor 1710 is connected to other system components, including one or more memory devices 1712, by the bus 1714. The memory 1712 stores programs and data during operation of the computer system 1702. Thus, the memory 1712 may be a relatively high performance, volatile, random access memory such as a dynamic random access memory (DRAM) or static memory (SRAM). However, the memory 1712 may include any device for storing data, such as a disk drive or other nonvolatile storage device. Various examples may organize the memory 1712 into particularized and, in some cases, unique structures to perform the functions disclosed herein. These data structures may be sized and organized to store values for particular data and types of data.

Components of the computer system 1702 are coupled by an interconnection element such as the bus 1714. The bus 1714 may include one or more physical busses, for example, busses between components that are integrated within a same machine, but may include any communication coupling between system elements including specialized or standard computing bus technologies such as IDE, SCSI, PCI and InfiniBand. The bus 1714 enables communications, such as data and instructions, to be exchanged between system components of the computer system 1702.

The computer system 1702 also includes one or more interface devices 1716 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1702 to exchange information and to communicate with external entities, such as users and other systems.

The data storage 1718 includes a computer readable and writeable nonvolatile, or non-transitory, data storage medium in which instructions are stored that define a program or other object that is executed by the processor 1710. The data storage 1718 also may include information that is recorded, on or in, the medium, and that is processed by the processor 1710 during execution of the program. More specifically, the information may be stored in one or more data structures specifically configured to conserve storage space or increase data exchange performance. The instructions may be persistently stored as encoded signals, and the instructions may cause the processor 1710 to perform any of the functions described herein. The medium may, for example, be optical disk, magnetic disk or flash memory, among others. In operation, the processor 1710 or some other controller causes data to be read from the nonvolatile recording medium into another memory, such as the memory 1712, that allows for faster access to the information by the processor 1710 than does the storage medium included in the data storage 1718. The memory may be located in the data storage 1718 or in the memory 1712, however, the processor 1710 manipulates the data within the memory, and then copies the data to the storage medium associated with the data storage 1718 after processing is completed. A variety of components may manage data movement between the storage medium and other memory elements and examples are not limited to particular data management components. Further, examples are not limited to a particular memory system or data storage system.

Although the computer system 1702 is shown by way of example as one type of computer system upon which various aspects and functions may be practiced, aspects and functions are not limited to being implemented on the computer system 1702 as shown in FIG. 17. Various aspects and functions may be practiced on one or more computers having a different architectures or components than that shown in FIG. 17. For instance, the computer system 1702 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1702 may be a computer system including an operating system that manages at least a portion of the hardware elements included in the computer system 1702. In some examples, a processor or controller, such as the processor 1710, executes an operating system. Examples of a particular operating system that may be executed include a Windows-based operating system, such as, Windows NT, Windows 2000 (Windows ME), Windows XP, Windows Vista, Windows 7 or Windows 8 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 1710 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used.

Alternatively, functional, scripting, or logical programming languages may be used. Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Having thus described several aspects of at least one embodiment, it is to be appreciated various alterations, modifications, and improvements will readily occur to those skilled in the art. For example, although the bulk of this disclosure focuses on farm products, some embodiments may be directed toward distribution of other goods or services, (e.g., custom-made furniture, crafts, quilts, pre-owned personal items, personal services, etc.). Such alterations, modifications, and improvements are intended to be part of this disclosure, and are intended to be within the scope of the embodiments disclosed herein. Accordingly, the foregoing description and drawings are by way of example only.

What is claimed is:

1. A method for selecting images for advertisements using a computer system, the method comprising:
computing, by the computer system, a plurality of valuations of a plurality of images, the plurality of valuations indicating levels of at least one of social engagement and personal engagement with the plurality of images; and
identifying at least one image from the plurality of images based on a valuation of the at least one image from the plurality of valuations.

2. The method according to claim 1, wherein computing the plurality of valuations includes computing one or more valuations based on engagement data.

3. The method according to claim 2, wherein computing the one or more valuations based on the engagement data includes computing at least one valuation based on a time of engagement included in the engagement data.

4. The method according to claim 2, wherein computing the one or more valuations based on the engagement data includes computing at least one valuation based on a frequency of engagement included in the engagement data.

5. The method according to claim 2, wherein computing the one or more valuations based on the engagement data includes computing at least one valuation based on a sharing metric included in the engagement data.

6. The method according to claim 1, wherein computing the plurality of valuations includes terminating computation within a predetermined time limit.

7. The method according to claim 6, wherein computing the plurality of valuations includes performing multiple valuations in parallel.

8. The method according to claim 7, wherein performing the multiple valuations includes identifying the valuation of the at least one image as being higher than another valuation of the plurality of valuations.

9. A computer system for selecting images for advertisements comprising:
a memory; and
at least one processor coupled to the memory, the at least one processor configured to:
compute a plurality of valuations of a plurality of images, the plurality of valuations indicating levels of at least one of social engagement and personal engagement with the plurality of images; and
identify at least one image from the plurality of images based on a valuation of the at least one image from the plurality of valuations.

10. The computer system according to claim 9, wherein the at least one processor is configured to compute the plurality of valuations by computing one or more valuations based on engagement data.

11. The computer system according to claim 10, wherein the at least one processor is configured to compute the one or more valuations based on the engagement data by computing at least one valuation based on a time of engagement included in the engagement data.

12. The computer system according to claim 10, wherein the at least one processor is configured to compute the one or more valuations based on the engagement data by computing at least one valuation based on a frequency of engagement included in the engagement data.

13. The computer system according to claim 10, wherein the at least one processor is configured to compute the one or more valuations based on the engagement data by computing at least one valuation based on a sharing metric included in the engagement data.

14. The computer system according to claim 9, wherein the at least one processor is configured to compute the plurality of valuations by terminating computation within a predetermined time limit.

15. The computer system according to claim 14, wherein the at least one processor is configured to compute the plurality of valuations by performing multiple valuations in parallel.

16. The computer system according to claim 15, wherein the at least one processor is configured to perform the multiple valuations by identifying the valuation of the at least one image as being higher than another valuation of the plurality of valuations.

17. A non-transitory computer readable medium storing instructions for selecting images for advertisements, the instructions being executable by at least one processor of a computer system, the instructions instructing the computer system to:
compute a plurality of valuations of a plurality of images, the plurality of valuations indicating levels of at least one of social engagement and personal engagement with the plurality of images; and
identify at least one image from the plurality of images based on a valuation of the at least one image from the plurality of valuations.

18. The non-transitory computer readable medium according to claim 17, wherein the instructions that instruct the computer system to compute the plurality of valuations include instructions that instruct the computer system to compute one or more valuations based on engagement data.

19. The non-transitory computer readable medium according to claim 18, wherein the instructions that instruct the computer system to compute the one or more valuations based on the engagement data include instructions that instruct the computer system to compute at least one valuation based on a time of engagement included in the engagement data.

20. The non-transitory computer readable medium according to claim 18, wherein the instructions that instruct the computer system to compute the one or more valuations based on the engagement data include instructions that instruct the computer system to compute at least one valuation based on a frequency of engagement included in the engagement data.

21. The non-transitory computer readable medium according to claim 18, wherein the instructions that instruct the computer system to compute the one or more valuations based on the engagement data include instructions that instruct the computer system to compute at least one valuation based on a sharing metric included in the engagement data.

22. The non-transitory computer readable medium according to claim 17, wherein the instructions that instruct the computer system to compute the plurality of valuations include instructions that instruct the computer system to terminate computation within a predetermined time limit.

23. The non-transitory computer readable medium according to claim 22, wherein the instructions that instruct the computer system to compute the plurality of valuations include instructions that instruct the computer system to perform multiple valuations in parallel.

24. The non-transitory computer readable medium according to claim 23, wherein the instructions that instruct the computer system to perform the multiple valuations include instructions that instruct the computer system to identify the valuation of the at least one image as being higher than another valuation of the plurality of valuations.
